(19) United States
(12) Patent Application Publication
(10) Pub. No.: US 2007/0231505 A1
(43) Pub. Date: Oct. 4, 2007

(54) Polarizing Plate and Liquid Crystal Display Device

(75) Inventor: Keiichi Taguchi, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/630,491

(22) PCT Filed: Jun. 22, 2005
(86) PCT No.: PCT/JP05/11871

§ 371 Date: Dec. 22, 2006

(30) Foreign Application Priority Data
Jun. 22, 2004 (JP) 2004-183811

(51) Int. Cl. G02B 5/30; G02F 1/1335

(52) U.S. Cl. 428/1.31; 349/96

(57) ABSTRACT

A polarizing plate is provided and includes a polarizing film and two transparent protective film, at least one of the two transparent protective films being an optical compensation sheet, the optical compensation sheet being a cellulose acylate film having a thickness of from 40 μm to 180 μm. The polarization degree P of the polarizing plate is 99.9% or more and the thickness of the polarizing film is 22 μm or less. A VA mode liquid crystal display device is provided and includes the polarizing plate.

### TECHNICAL FIELD

The present invention relates to a polarizing plate comprising an optical compensation sheet of a cellulose acylate film, and a liquid crystal display device using the same.

### BACKGROUND ART

A polarizing plate is normally produced by sticking a film mainly containing a cellulose triacetate as a transparent protective film to the both sides of a polarizing film having iodine or a dichromatic dye oriented and adsorbed therein. A cellulose triacetate is characterized by a high toughness, a high fire retardancy and a high optical isotropy (low retardation value) and thus has been widely used as a transparent protective film for the aforementioned polarizing plate.

A liquid crystal display device includes a polarizing plate and a liquid crystal cell. At present, in a TN mode TFT liquid crystal display device, which is a mainstream of liquid crystal display device, an optical compensation sheet (retarder film) is provided interposed between the polarizing plate and the liquid crystal cell to realize a liquid crystal display device having a high display quality as disclosed in JP-A-8-50206. However, this method is disadvantageous in that the thickness of the liquid crystal display device itself increases.

On the other hand, JP-A-1-68940 proposes that the polarizing film can have an optical compensation sheet provided on one side thereof and a protective film provided on the other to raise the front contrast without raising the thickness of the liquid crystal display device. However, the optical compensation sheet of JP-A-1-68940 was found disadvantageous in that some strain such as heat can easily cause phase difference resulting in light leakage.

Referring to the problem of the occurrence of phase difference due to strain, JP-A-7-191217 and EP 0 911 656 A2 disclose a technique involving the direct use of an optical compensation sheet as a protective film for polarizing plate, the compensation sheet having an optically anisotropic layer containing a discotic compound spread over a transparent support. In this arrangement, the aforementioned problems can be solved without raising the thickness of the liquid crystal display device.

However, even these approaches leave something to be desired in the prevention of light leakage due to strain such as heat in liquid crystal panels having a size of 15 inch or more. Liquid crystal display devices including a polarizing plate having an optical compensation sheet and a polarizing plate integrated to each other exhibit a wide viewing angle but are disadvantageous in that they leave something to be desired in hue and cause light leakage as the size of the liquid crystal panel increases.

Further, polarizing plates in the related art include a polarizing film having a thickness of about 25 μm. In particular, when used for liquid crystal monitors having a size of 15 inch or more, polarizing plates in the related art cause a trouble of light leakage from the circumference of the monitor. It has thus been desired to eliminate these problems. Nevertheless, marketed polarizing films have a thickness of 22.5 μm at minimum.

### DISCLOSURE OF THE INVENTION

An object of an illustrative, non-limiting embodiment of the invention is to provide a polarizing plate which optically compensates a liquid crystal cell and causes little light leakage with time.

Another object of an illustrative, non-limiting embodiment of the invention is to provide a VA mode liquid crystal display device having a wide viewing angle and little light leakage with time.

Also, the invention is not required to overcome the disadvantage described above (e.g., light leakage), and an illustrative, non-limiting embodiment of the invention may overcome a different disadvantage or may not overcome any disadvantages.

The inventors made extensive studies of solution to the aforementioned problems. As a result, it was found that the shrinkage of the polarizing film in the polarizing plate used in liquid crystal display devices with time causes the occurrence of light leakage, and that the occurrence of light leakage with time can be eliminated by reducing the thickness of polarizing film. Thus, the invention has been worked out. In other words, the invention has the following constitutions.
1. A polarizing plate comprising:

a polarizing film; and

two transparent protective films, wherein the polarizing film is between the two transparent protective films, and at least one of the transparent protective films is an optical compensation sheet comprising a cellulose acylate film, the cellulose acylate film having a thickness of from 40 to 180 μm,

wherein

the polarizing film has a thickness of 22 μm or less, and

the polarizaing plate has a polarization degree P calculated by formula (1) of 99.9% or more:
Polarization degree P=((H0−H1)/(H0+H1))^{1/2}×100 (1)
wherein H0 represents a transmittance of two polarizing plates at the time the two polarizing plates are stacked on each other such that absorption axes of the two polarizing plates correspond with each other; and H1 represents a transmittance of two polarizing plates at the time the two polarizing plates are stacked on each other such that absorption axes of the two polarizing plates are perpendicular to each other.
2. The polarizing plate as defined in Clause 1, wherein the polarizing film has a thickness of 20 μm or less.
3. The polarizing plate as defined in Clause 1 or 2, wherein the optical compensation sheet has: an Re retardation value of from 20 to 80 nm; an Rth retardation value of from 70 to 400 nm; and a ratio of the Re retardation value to the Rth retardation value of from 0.1 to 0.5.
4. The polarizing plate as defined in Clause 3, wherein the cellulose acylate film comprises a mixed aliphatic acid ester of cellulose, wherein a hydroxyl group of the cellulose is substituted by an acetyl group, and another hydroxyl group of the cellulose is substituted by an acyl group having 3 or more carbon atoms; and the cellulose acylate satisfies formulae (4) and (5):
   2.0≦A+B≦3.0 (4)
   0<B (5)
   wherein A is a degree of substitution by the acetyl group; and B is a degree of substitution by the acyl group having 3 or more carbon atoms.
5. The polarizing plate as defined in Clause 4, wherein the acyl group is a butyryl group.
6. The polarizing plate as defined in Clause 4, wherein the acyl group is a propionyl group, and the degree B is 1.3 or more.
7. The polarizing plate as defined in any one of Clauses 4 to 6, wherein a sum of the degree of substitution of hydroxyl group in a 6-position of cellulose is 0.75 or more.
8. The polarizing plate as defined in any one of Clauses 4 to 7, wherein DS2, DS3 and DS6 respectively representing degrees of substitution of hydroxyl groups in 2, 3 and 6 positions of a glucose unit of the cellulose by an acyl group having 2 or more carbon atoms satisfy:
   2.0≦DS2+DS3+DS6≦3.0 (I)
   DS6/(DS2+DS3+DS6)≧0.315 (II)
9. The polarizing plate as defined in any one of Clauses 1 to 8, wherein the cellulose acylate film comprises a compound containing at least two aromatic rings in an amount of from 0.01 to 20 parts by weight based on 100 parts by weight of cellulose acylate.
10. The polarizing plate as defined in Clause 9, wherein the compound containing at least two aromatic rings is a rod-shaped compound having a linear molecular structure.
11. The polarizing plate as defined in any one of Clauses 1 to 10, wherein the cellulose acylate film is a film stretched at a draw ratio of from 3 to 100%.
12. The polarizing plate as defined in Clause 11, wherein the cellulose acylate film comprises a cellulose acetate having: an acetylation degree of from 59.0 to 61.5%; and an amount of Re/Rth change of from 0.01 to 0.1.
13. The polarizing plate as defined in any one of Clauses 1 to 12, wherein the cellulose acylate film is a film stretched in a direction perpendicular to a longitudinal direction with a content of residual solvent in the cellulose acylate film, the content being kept to a range of from 2 to 30% by weight while the film being conveyed in the longitudinal direction; and the optical compensation sheet has a slow axis aligned in the direction perpendicular to the longitudinal direction thereof.
14. The polarizing plate as defined in any one of Clauses 1 to 13, wherein one of the two transparent protective films is the optical compensation sheet comprising the cellulose acylate film; the other of the two transparent protective films has an anti-reflection layer having a specular reflectance of 2.5% or less; and the anti-reflection layer comprises a light-scattering layer and a lower refractive layer.
15. The polarizing plate as defined in any one of claims 1 to 13, wherein one of the two transparent protective films is the optical compensation sheet comprising the cellulose acylate film; the other of the two transparent protective films has an anti-reflection layer having a specular reflectance of 0.5% or less; and the anti-reflection layer comprises a middle refractive layer, a higher refractive layer, and a lower refractive layer in this order.
16. A liquid crystal display device comprising:

a liquid crystal cell of VA mode; and

two polarizing plates, wherein the liquid crystal cell is between the two polarizing plate, and at least one of the two polarizing plates is a polarizing plate as defined in any one of Clauses 1 to 15,

wherein

the optical compensation sheet of the polarizing plate is disposed on a liquid crystal cell side of the polarizing film,

and a slow axis of the optical compensation sheet and a transmission axis of the polarizing film adjacent to the optical compensation sheet are aligned substantially parallel to each other.
17. A liquid crystal display device comprising:

a liquid crystal cell of VA mode; and

two polarizing plates, wherein the liquid crystal cell is between the two polarizing plate, and at least one of the two polarizing plates is a polarizing plate as defined in Clause 14 or 15,

wherein

the anti-reflection layer is disposed on a viewing side of the polarizing film, and

a slow axis of the optical compensation sheet and a transmission axis of the polarizing film adjacent to the optical compensation sheet are aligned substantially parallel to each other.

The term “substantially parallel” as used herein is meant to indicate that the angle falls within a range of from 5° less, preferably 4° less, more preferably 3° less, most preferably 2° less than the accurate angle to 5° more, 4° more, more preferably 3° more, most preferably 2° more than the accurate angle.

In accordance with the invention, when the thickness of the polarizing film is predetermined to be not more than the related art value, a polarizing plate can be provided which can make optical compensation of liquid crystal cell and shows little light leakage with time while inhibiting the occurrence of the related art problems. The polarizing plate of the invention can make sufficient optical compensation of liquid crystal cell to enhance the viewing angle properties. The VA mode liquid crystal display device of the invention provides a wide viewing angle and little light leakage with time.

### DETAILED DESCRIPTION OF THE INVENTION

As previously mentioned, an exemplary embodiment of the polarizing plate of the invention causes little light leakage with time when the thickness thereof is not more than a value.

In other words, the aforementioned polarizing plate satisfies the following requirements (a) and (b):
(a) The polarization degree P calculated by the following formula (1) is 99.9% or more; and
(b) The thickness of the polarizing film is 22 μm or less.
   Polarization degree P=((H0−H1)/(H0+H1))^{1/2}×100 (1)
   wherein H0 represents a transmittance (%) of two poralizing plates at the time the two polarizing plates are stacked on each other such that absorption axes of the two polarizing plates are allowed to correspond (or coincide) with each other; and H1 represents a transmittance (%) of two polarizing plates at the time the two polarizing plates are stacked on each other such that absorption axes of the two polarizing plates are allowed to be perpendicular to each other.
   (Polarization Degree)

For the measurement of polarization degree, a Type UV3100 recording spectrophotometer can be used.

The polarization degree is determined by the aforementioned formula (1), wherein H0 represents a transmittance (%) at the time two polarizing plates are stacked on each other such that absorption axes of the two polarizing plates are allowed to correspond (or coincide) with each other; and H1 represents a transmittance (%) of the time two polarizing plates are stacked on each other such that absorption axes of the two polarizing plates are allowed to be perpendicular to each other. The polarization degree may be corrected based on visibility.

(Method of Reducing the Thickness of the Polarizing Film)

The reduction of the thickness of the polarizing film can be attained by using in proper combination a method involving the enhancement of draw ratio in the related art stretching method, a method involving the use of a thin polymer film for stretching polarizing film, etc. For example, PVA film which is normally used as polymer film for polarizing film has a thickness of 75 μm (e.g., VF-P, VF-PS (produced by KURARAY CO., LTD.). When stretched by a factor of about 8 or more by a longitudinally monoaxial method, such a polarizing film has a thickness of 20 μm or less. Further, when stretched by a factor of 4 or more by a crosswise monoaxial stretching method, such a polarizing film has a thickness of 20 μm or less. Alternatively, a polymer film for polarizing film having a thickness of 50 μm or less can be stretched by a factor of about 6 or more by a monoaxial stretching method to provide a polarizing film having a thickness of 20 μm or less.

In the invention, a stretching method involving monoaxial stretching of a polymer film for polarizing film in the direction of conveyance followed by or accompanied by crosswise stretching may be used besides these monoaxial stretching methods. This method is generally called biaxial stretching method. As general examples of such a method there are known simultaneous biaxial stretching method involving tenter process and simultaneous biaxial stretching method involving tubular process. In accordance with this method, when a PVA film having a thickness of 75 μm is stretched longitudinally by a factor of about 4 or more and crosswise by a factor of about 1.5 or more, the resulting polarizing film has a thickness of 20 μm or less.

In the invention, the thickness of the polarizing film is preferably as small as possible from the standpoint of prevention of trouble causing the occurrence of light leakage (e.g., light leakage from the circumference of the monitor). However, when the thickness of the polarizing film is too small, troubles occur such as break of film during stretching, adverse effect on handling during dipping in a dye solution, a hardening solution or the like and cracking during drying after stretching. Accordingly, in the invention, the thickness of the polarizing film is preferably from not smaller than 5 μm to not greater than 22 μm, more preferably from not smaller than 8 μm to not greater than 20 μm.

(Description of Various Steps)

(Swelling Step)

The swelling of the polymer film is preferably effected with only water. As described in JP-A-10-153709, however, the polarizing film substrate may be swollen with an aqueous solution of boric acid to control the swell thereof for the purpose of stabilizing the optical properties and avoid the occurrence of wrinkle on the polarizing film in the production line.

The swelling temperature and time can be arbitrarily predetermined but are preferably from 10° C. to 50° C. and 5 seconds or more, respectively.

(Dyeing Step)

The dyeing of the polymer film can be carried out by the method disclosed in JP-A-2002-86554. The dyeing of the polymer film can be carried out not only by dipping but also by any other arbitrary method such as spreading and spraying of an iodine or dye solution.

The dichromatic material to be used in dyeing is not specifically limited, but the dyeing of the polymer film is preferably effected with iodine in a liquid phase.

In the case where iodine is used, the dyeing of the polymer film is carried out by dipping the polymer film in an aqueous solution of iodine and potassium iodide. The content of iodine is preferably from 0.05 to 20 g/l, more preferably from 0.5 to 2 g/l, the content of potassium iodide is preferably from 3 to 200 g/l, more preferably from 30 to 120 g/l, and the weight ratio of iodine and potassium iodide is preferably from 1 to 2,000, more preferably from 30 to 120. The dyeing time is preferably from 10 to 1,200 seconds, more preferably from 30 to 600 seconds. The temperature of the dyeing solution is preferably from 10 to 60° C., more preferably from 20 to 50° C. As previously mentioned, as a film hardener there is effectively added a boron compound such as boron-based compound and boric acid (e.g., boric acid, borax). Boric acid, if used, is preferably added in an amount of from 1 to 30 times the amount of iodine by weight.

Since it is important from the standpoint of maintenance of polarizing properties to keep the content of additives in the aqueous solution constant, it is preferred that the aqueous solution, if produced continuously, be replenished with iodine, potassium iodide, boric acid, etc. These replenishers may be in the form of either solution or solid. The replenisher, if used in the form of solution, may be a high concentration solution which is then added by portions as necessary.

It is also effective to add a boron-based compound such as boric acid and borax as a hardener so that the dyeing step and the hardening step described later can be effected at the same time. Boric acid, if used, is preferably added in an amount of from 1 to 30 times that of iodine by weight. At this step, a dichromatic dye is effectively used. The amount of the dichromatic dye to be added is preferably from 0.001 to 1 g/l. Since it is important from the standpoint of maintenance of polarizing properties to keep the content of additives in the aqueous solution constant, it is preferred that the aqueous solution, if produced continuously, be replenished with iodine, potassium iodide, boric acid, etc. These replenishers may be in the form of either solution or solid. The replenisher, if used in the form of solution, may be a high concentration solution which is then added by portions as necessary.

(Hardening Step)

The hardening of the polymer film is preferably carried out by dipping the polymer film in a solution of a crosslinking agent or by spreading or spraying a solution of a crosslinking agent over the polymer film. As described in JP-A-11-52130, the hardening step may be effected batchwise.

As the crosslinking agent there may be used one described in U.S. Pat. No. 232,897 (reissued), as a crosslinking agent there may be also used a polyvalent aldehyde to enhance the dimensional stability. Boric acids may be most preferably used.

In the case where as the crosslinking agent to be used at the hardening step there is used boric acid, the aqueous solution of boric acid and potassium iodide may comprise metallic ions incorporated therein. As one of the metallic ions there is preferably used zinc chloride ion. As described in JP-A-2000-35512, zinc halide such as zinc iodide or zinc salt such as zinc sulfate and zinc acetate may be used instead of zinc chloride.

Preferably, the polymer film is hardened by dipping in an aqueous solution of boric acid and potassium iodide having zinc chloride incorporated therein. The content of boric acid is preferably from 1 to 100 g/l, more preferably from 10 to 80 g/l, the content of potassium iodide is preferably from 1 to 120 g/l, more preferably from 5 to 100 g/l, the content of zinc chloride is preferably from 0.01 to 10 g/l, more preferably from 0.02 to 8 g/l, the hardening time is preferably from 10 to 1,200 seconds, more preferably from 30 to 600 seconds, and the temperature of the hardening solution is preferably from 10 to 60° C., more preferably from 20 to 50° C. As previously mentioned, the hardening time is from 30 to 600 seconds and the temperature of the hardening solution is from 20 to 50° C.

Since it is important from the standpoint of maintenance of polarizing properties to keep the content of additives in the aqueous solution constant, it is preferred that the aqueous solution, if produced continuously, be replenished with these additives as in the dyeing step.

(Stretching Step)

The stretching of the polymer film may be carried out by adjusting the polymer film such that a polarizing film having a thickness of 22 μm or less, preferably 20 μm or less, and then subjecting the polymer film thus adjusted to monoaxial stretching method as described in U.S. Pat. No. 2,454,515. In the invention, an oblique stretching method involving tenter process as described in JP-A-2002-86554 is preferably used as well.

(Drying Step)

Referring to the drying conditions, the drying of the polymer film can be effected according to the method described in JP-A-2002-86554.

(Protective Film Sticking Step)

A protective film is then stuck to one or both sides of the polarizing film produced according to the invention with an optical compensation sheet containing cellulose acylate to provide a polarizing plate. The kind of the protective film to be used is not specifically limited. Examples of the protective film employable herein include cellulose esters such as cellulose acetate, cellulose acetate butyrate and cellulose propionate, polycarbonates, polyolefins, polystyrenes, and polyesters. Examples of commercially available protective films include Fujitac (produced by Fuji Photo Film Co., Ltd.), triacetyl cellulose film produced by Konica Co., Ltd., Zeonoa (produced by ZEON CORPORATION), and Arton (produced by Nihon Synthetic Rubber Co., Ltd.). Other examples of the protective film include nonbirefringent optical resin materials as described in JP-A-8-110402, and JP-A-11-293116.

The protective film for polarizing plate is required to have physical properties such as transparency, proper moisture permeability, low birefringence and proper rigidity. The thickness of the protective film is preferably from 5 to 500 μm, more preferably from 20 to 200 μm, particularly from 20 to 100 μm from the standpoint of handleability and durability.

The adhesive for bonding the polarizing film and the protective film to each other is not specifically limited. Examples of the adhesive employable herein include PVA-based resins (including modified PVA having acetoacetyl group, sulfonic acid group, carboxyl group or oxyalkylene group incorporated therein), and aqueous solution of boron compound. Preferred among these adhesives are PVA-based resins.

The polarizing film and the protective film are preferably stuck to each other by supplying the adhesive shortly before sticking, and then sticking the two films using a pair of rolls such that the two films are stacked on each other.

The dried thickness of the adhesive layer is preferably from 0.001 to 5 μm, particularly from 0.005 to 3 μm. As described in JP-A-2001-296426 and JP-A-2002-86554, in order to inhibit the occurrence of record groove-like unevenness attributed to the stretching of the polarizing film, the water content in the polarizing film during sticking is preferably adjusted, more preferably to a range of from 0.1% to 30% in the invention.

(Drying Step After Sticking)

Referring to the conditions of drying after sticking, the layerd product is dried according to the method described in JP-A-2002-76554.

In the polarizing plate of the invention, the content of iodine, boron, potassium and zinc in the polarizing film are preferably from 0.1 to 3.0 g/m², from 0.1 to 5.0 g/m², from 0.1 to 2.0 g/m² and from 0.001 to 2.0 g/m², respectively.

(Polymer Film for Polarizing Film)

The polymer film for polarizing film to be used in the invention is preferably a PVA film.

PVA is a saponification product of polyvinyl acetate. PVA may comprise a component copolymerizable with vinyl acetate such as unsaturated carboxylic acid, unsaturated sulfonic acid, olefin and vinylether incorporated therein. Further, a modified PVA comprising an acetoacetyl group, sulfonic acid group, carboxyl group, oxyalkylene group or the like incorporated therein may be used.

The saponification degree of PVA is not specifically limited but is preferably from 80 to 100 mol-%, particularly from 90 to 100 mol-% from the standpoint of solubility, etc. The polymerization degree of PVA is not specifically limited but is preferably from 1,000 to 10,000, particularly from 1,500 to 5,000.

The crystallization degree of PVA film is not specifically limited. By way of example, a PVA film having an average crystallization degree (Xc) of from 50 to 75% by weight as described in Japanese Patent No. 3,251,073 is preferably used. As described in JP-A-2002-236214, in order to eliminate the in-plane dispersion of hue, a PVA film having a crystallization degree of 38% or less is preferably used.

The birefringence (Δn) of the PVA film is preferably as small as possible. As described in Japanese Patent No. 3,342,516, a PVA film having a birefringence of 1.0×10⁻³ or less is preferably used. However, as described in JP-A-2002-228835, in order to attain a high polarization degree while avoiding the breakage of PVA film during stretching, the birefringence of the PVA film may be predetermined to be from not smaller than 0.02 to not greater than 0.01.

As described in Japanese Patent No. 2,978,219, a PVA film having a syndiotacticity of 55% or more is preferably used to enhance the durability thereof. As described in Japanese Patent No. 3,317,494, a PVA film having a syndiotacticity of from 45 to 52.5 mol-% may be used.

The polarizing plate of the invention may preferably comprise a PVA film having 1,2-glycol bonded thereto in an amount of 1.5 mol-% or less as described in Japanese Patent No. 3,021,494, a PVA film comprising optical foreign materials having a size of 5 μm or more in a proportion of 500 particles per 100 cm² as described in JP-A-2001-316492, a PVA film having a hot water cutting temperature of 1.5° C. or less in TD direction as described in JP-A-2002-30163 or a PVA film prepared from a solution having a plasticizer incorporated therein as described in JP-A-6-298225 incorporated therein besides these PVA films.

As a method of producing PVA film there is normally used preferably a method which comprises casting a stock solution obtained by dissolving a PVA-based resin in water or an organic solvent. The concentration of the polyvinyl alcohol-based resin in the stock solution is normally from 5 to 20% by weight. By casting the stock solution, a PVA film having a thickness of from 10 to 200 μm can be produced. For the details of the production of PVA film, reference can be made to Japanese Patent No. 3,342,516, JP-A-9-328593, JP-A-2001-302817, and JP-A-2002-144401.

(Configuration of Polarizing Plate)

The protective film for the polarizing plate of the invention or the optical compensation sheet made of cellulose acylate may have an arbitrary functional layer such as a reflecting polarizer, an optically anisotropic layer for compensating the viewing angle of LCD as disclosed in JP-A-4-229828, JP-A-6-75115 and JP-A-8-50206, an anti-glare or anti-reflection layer for enhancing the viewability of display, a hard coat layer for enhancing the scratch resistance of the polarizing plate, a gas barrier layer for inhibiting the dispersion or water or oxygen, an easily bondable layer for enhancing the adhesion to the polarizing film or adhesive agent and a layer for providing slipperiness provided on the surface thereof.

As the protective film for polarizing plate there may be used one or a layered product of the aforementioned preferred protective films. The same protective film may be stuck to the both sides of the polarizing film. Alternatively, protective films having different functions and physical properties may be stuck to the respective side of the polarizing film.

(Adhesive Layer)

The aforementioned adhesive layer to be provided to stick the polarizing plate of the invention directly to the liquid crystal cell is a layer which exhibits a proper viscoelasticity or adhesivity, not to mention optical transparency. The adhesive layer of the invention can be formed by spreading a coating solution made of an acryl-based copolymer, epoxy-based resin, polyurethane, silicon-based polymer, polyether, butyral-based resin, polyamide-based resin, polyvinyl alcohol-based resin or polymer composition containing a synthetic rubber over a polarizing film, and then drying the coat layer by drying method, chemical curing method, thermosetting method, heat fusion method, photo-setting method or the like. In particular, an acryl-based copolymer is preferably used because it allows easy control over adhesive properties and is excellent in transparency, weathering resistance and durability.

(Optical Compensation Sheet)

As previously mentioned, the polarizing plate of the invention satisfies the aforementioned requirements (a) and (b) and comprises two transparent protective films disposed on the respective side of a polarizing film, at least one of the two transparent protective film being an optical compensation sheet of a cellulose acylate film having a thickness of from 40 μm to 180 μm.

The cellulose acylate film to be used as an optical compensation sheet is preferably adjusted in its retardation. The retardation will be further described hereinafter.

(Retardation of Optical Compensation Sheet)

An Re retardation value and an Rth retardation value are defined as follows.

In the present specification, Re (λ) represents a retardation value in the film (or sheet) plane at wavelength λ and Rth (λ) represents a retardation value in the thickness direction at wavelength λ. Re (λ) is measured, with use of KOBRA 21ADH (a product of Oji Scientific Instruments, Ltd., by irradiating the light with a wavelength of λ nm in the direction normal to the film plane. KOBRA 21ADH calculates Rth (λ) based on the retardation values measured in three directions, whereby a first one is the above-described Re (λ), second one is a retardation value measured by radiating light with a wavelength of λ nm from the direction tilted by +40° relative to the one normal to the film plane with an axis of tilt (rotational axis) of the retarded phase axis within the plane (which is judged by KOBRA 21ADH), and a third one measured by radiating the light with a wavelength of λ nm from the direction tilted by −40° relative to the one normal to the film plane with an axis of tilt (rotational axis) of the retarded phase axis within the plane, together with an assumed value for the average refractive index and the input layer thickness. Here, as the assumed value of the average refractive index, those set forth in “Polymer Handbook” (John Wiley & Sons, Inc.) and those in the catalogues of various optical films can be adopted. Those, whose average refractive indices are unknown, can be subjected to the measurements with an Abbe refractometer. In the following, the average refractive indices of main optical films are enumerated. Cellulose acylate (1.48), cyclo-olefin polymer (1.52), polycarbonate (1.59), poly(methyl methacrylate) (1.49), and polystyrene (1.59). By inputting the assumed value of such an average refractive index and the layer thickness, KOBRA 21ADH calculates nx, ny and nz, from which Nz=(nx−nz)/(nx−ny) is further calculated.

In the invention, it is preferred that Re retardation value and Rth retardation value of the cellulose acylate film be from 20 to 80 nm, more preferably from 40 to 70 nm and from 70 to 400 nm, more preferably from 80 to 300 nm, respectively. In the invention, the Re/Rth ratio is adjusted to a range of from 0.1 to 0.5, more preferably from 0.2 to 0.4, even more preferably from 0.3to 0.4.

The adjustment of these factors can be carried out by properly adjusting the substitution degree of cellulose acylate film, the kind and amount of additives in the cellulose acylate film or the production conditions (e.g., film stretching conditions) to the above defined range. It is particularly preferred that the additive be a rod-shaped compound having at least two aromatic rings and a linear molecular structure. Referring to the production conditions, these factors are preferably adjusted by draw ratio.

In the invention, the amount of Re/Rth change per % of draw ratio is preferably from 0.01 to 0.1. The amount of Re/Rth change per % of draw ratio can be determined by the gradient obtained by the linear approximation of Re/Rth ratio at at least three draw ratios of not smaller than 5%. The adjustment of the amount of Re/Rth change can be attained by changing the acetylation degree, adjusting the substitution degrees A and B to be hereinafter described, selecting acyl groups of the cellulose acylate (butyryl or propionyl), or adding a compound having an aromatic ring, etc.

The birefringence (nx−ny) of the cellulose acylate film is preferably from 0.0002 to 0.0009, more preferably from 0.00025 to 0.0009, most preferably from 0.00035 to 0.0009. The birefringence of the cellulose acylate film in the thickness direction {(nx+ny)/2−nz} is preferably from 0.0006 to 0.005, more preferably from 0.0008 to 0.005, most preferably from 0.0012 to 0.005.

(Moisture Permeability of Optical Compensation Sheet)

In the invention, the moisture permeability of the optical compensation sheet is preferably adjusted to 700 g/m²·day or less, more preferably 500 g/m²·day or less at 40° C. and 90% RH.

For the measurement of moisture permeability, the method described in “Physical Properties of Polymers II”, Institute of Polymer Experiment 4, Kyoritshu Shuppan, pp. 285-294: Measurement of Vapor Moisture (weight method, thermometer method, vapor pressure method, adsorption method) can be used.

The adjustment of moisture permeability can be carried out by properly adjusting the kind and amount of the additives in the cellulose acylate film to the above defined range. It is particularly preferred that the moisture permeability be adjusted with a retardation adjustor.

(Cellulose Acylate Composition)

The compounds to be incorporated in the composition from which the cellulose acylate film is prepared will be sequentially described hereinafter.

(Cellulose Acylate)

As a cotton from which the cellulose acylate of the invention is produced there may be used any known cotton material (as disclosed in Kokai Giho No. 2001-1745, Japan Institute of Invention and Innovation). Further, the synthesis of the cellulose acylate can be attained by any known method (as disclosed in Migita et al, “Wood Chemistry”, pp. 180-190, Kyoritsu Shuppan, 1968). The viscosity-average polymerization degree of the cellulose acylate is preferably from 200 to 700, more preferably from 250 to 500, most preferably from 250 to 350. The distribution of molecular weight Mw/Mn (Mw: weight-average molecular weight; Mn: number-average molecular weight) of the cellulose acylate to be used in the invention is preferably sharp as determined by gel permeation chromatography. In some detail, Mw/Mn is preferably from 1.5 to 5.0, more preferably from 2.0 to 4.5, most preferably from 3.0 to 4.0.

The cellulose acylate to be used in the invention is preferably a cellulose acylate wherein the degree of substitution of hydroxyl group in cellulose satisfies formulae (4) and (5):
2.0≦A+B≦3.0 (4)
0≦B (5)
wherein A and B each represent the degree of substitution of hydroxyl group by acyl groups in cellulose in which A represents the degree of substitution by an acetyl group; and B represents the degree of substitution by an acyl group having 3 or more carbon atoms, preferably C₃-C₂₂ acyl group.

The β-1,4-bonded glucose unit constituting the cellulose has a free hydroxyl group in the 2-, 3- and 6-positions. The cellulose acylate is a polymer obtained by esterification of some or whole of these hydroxyl groups by acyl group. The degree of substitution by acyl group means the ratio of esterification of cellulose each in the 2-, 3- and 6-positions (100% esterification means a substitution degree of 1).

In the invention, the sum of the degrees A and B of substitution of hydroxyl group is preferably from 2.2 to 2.86, particularly from 2.40 to 2.80. The degree B of substitution is preferably 0 or more, more preferably 1.3 or more, still more prefereably 1.50 or more, particularly 1.7 or more. Referring further to B, the hydroxyl groups in the 6-position are preferably substituted in a proportion of not smaller than 28%, more preferably not smaller than 30%, even more preferably not smaller than 31%, particularly not smaller than 32%. Further, the sum of the degrees A and B of substitution in the 6-position of cellulose acylate is preferably 0.75 or more, more preferably 0.80 or more, particularly 0.85 or more.

Particularly preferable cellulose acylates among those cited above are such that satisfy the following formulae (I) and (II) in which DS2 represents the degree of substitution of the hydroxyl group in the 2-position for the glucose unit of cellulose by acyl groups having 2 or more carbon atoms (i.e., an acetyl group and an acyl group having 3 or more carbon atoms), DS3 represents the degree of substitution of the hydroxyl group in the 3-position by acetyl groups, and DS6 represents the degree of substitution of the hydroxyl group at the 6-position by acetyl group and an acyl group with 3 or more carbon atoms.
2.0≦DS2+DS3+DS6≦3.0 (I)
DS6/(DS2+DS3+DS6)≧0.315 (II)
The cellulose acylate satisfying formaulae (I) and (II), which readily develops retardation, is preferable for the invention.

The acyl group in the aforementioned cellulose acylate film is not specifically limited but is preferably an acetyl group, propionyl group or butyryl group. The term “degree of substitution of acyl group” as used herein is meant to indicate the value calculated according to ASTM D817.

In the case where a cellulose acetate having an acetyl group as an acyl group is used, the acetylation degree is preferably from 59.0 to 62.5%, more preferably from 59.0 to 61.5%. When the acetylation degree falls within this range, Re is not greater than the desired value due to conveyance tension during casting. Further, there occurs little in-plane dispersion of Re. Moreover, there occurs little change of retardation value with temperature and humidity.

(Retardation Adjustor)

In order to adjust the retardation value of the cellulose acylate film, it is preferred that an aromatic compound having at least two aromatic rings be used as a retardation adjustor. The aromatic compound is preferably used in an amount of from 0.01 to 20 parts by weight, more preferably from 1 to 20 parts by weight based on 100 parts by weight of cellulose acylate. Two or more aromatic compounds may be used in combination. The aromatic rings in the aromatic compound include aromatic heterocyclic groups in addition to aromatic hydrocarbon rings.

The aromatic hydrocarbon ring is particularly preferably a 6-membered ring (i.e., benzene ring). The aromatic heterocyclic group is normally an unsaturated heterocyclic group, preferably a 5-membered, 6-membered or 7-membered ring, more preferably a 5-membered ring or 6-membered ring.

The aromatic heterocyclic group normally has most numerous double bonds. As the hetero atoms there are preferably nitrogen atom, oxygen atom and sulfur atom, particularly nitrogen atom. Examples of the aromatic heterocyclic group include furane ring, thiophene ring, pyrrole ring, oxazole ring, isooxazole ring, thiazole ring, isothiazole ring, imidazole ring, pyrazole ring, furazane ring, triazole ring, pyrane ring, pyridine ring, pyridazine ring, pyrimidine ring, pyrazine ring, and 1,3,5-triazine ring. Preferred examples of the aromatic ring include benzene ring, furane ring, thiophene ring, pyrrole ring, oxazole ring, thiazole ring, imidazole ring, triazole ring, pyridine ring, pyrimidine ring, pyrazine ring, and 1,3,5-triazine ring. Particularly preferred among these aromatic rings is 1,3,5-triazine ring. It is particularly preferred that the aromatic compound have at least one 1,3,5-triazine ring.

The number of aromatic rings contained in the aforementioned aromatic compound is preferably from 2 to 20, more preferably from 2 to 12, even more preferably from 2 to 8, most preferably from 2 to 6. Referring to the connection of two aromatic rings, (a) they may form a condensed ring, (b) they may be connected directly to each other by a single bond or (c) they may be connected to each other via a connecting group (No spiro bond cannot be formed due to aromatic ring). Any of the connections (a) to (c) may be established.

Preferred examples of the condensed ring (a) (formed by the condensation of two or more aromatic rings) include indene ring, naphthalene ring, azlene ring, fluorene ring, phenathrene ring, anthracene ring, acenaphthylene ring, biphenylene ring, naphthacene ring, pyrene ring, indole ring, isoindole ring, benzofurane ring, benzothiophene ring, benzotriazole ring, purine ring, indazole ring, chromene ring, quinoline ring, isoquinoline ring, quinolidine ring, quinazoline ring, cinnoline ring, quinoxaline ring, phthaladine ring, puteridine ring, carbazole ring, acridine ring, phenathridine, xanthene ring, phenazine ring, phenothiazine ring, phenoxathine ring, phenoxazine ring, and thianthrene ring. Preferred among these condensed rings are naphthalene ring, azlene ring, indole ring, benzooxazole ring, benzothiazole ring, benzoimidazole ring, benzotriazole ring, and quinoline ring.

The single bond (b) is preferably a bond between the carbon atom of two aromatic rings. Two or more aromatic rings may be connected via two or more single bonds to form an aliphatic ring or nonaromatic heterocyclic group between the two aromatic rings.

The connecting group (c), too, is preferably connected to the carbon atom of two aromatic rings. The connecting group is preferably an alkylene group, alkenylene group, alkynylene group, —CO—, —O—, —NH—, —S— or combination thereof. Examples of the connecting group comprising these groups in combination will be given below. The order of the arrangement of components in the following connecting groups may be inverted.
c1: —CO—O—
c2: —CO—NH—
c3: -alkylene-O—
c4: —NH—CO—NH—
c5: —NH—CO—O—
c6: —O—CO—O—
c7: —O-alkylene-O—
c8: —CO-alkenylene-
c9: —CO-alkenylene-NH—
c10: —CO-alkenylene-O—
c11: -alkylene-CO—O-alkylene-O—CO-alkylene-
c12: —O-alkylene-CO—O-alkylene-O—CO-alkylene-O—
c13: —O—CO-alkylene-CO—O—
c14: —NH—CO-alkenylene-
c15: —O—CO-alkenylene-

The aromatic ring and connecting group may have substituents. Examples of the substituents include halogen atoms (F, Cl, Br, I), hydroxyl groups, carboxyl groups, cyano groups, amino groups, sulfo groups, carbamoyl groups, sulfamoyl groups, ureido groups, alkyl groups, alkenyl groups, alkinyl groups, aliphatic acyl groups, aliphatic acyloxy groups, alkoxy groups, alkoxycarbonyl groups, alkoxycarbonylamino groups, alkylthio groups, alkylsulfonyl groups, aliphatic amide groups, aliphatic sulfonamide groups, aliphatic substituted amino groups, aliphatic substituted carbamoyl groups, aliphatic substituted sulfamoyl groups, aliphatic substituted ureido groups, and nonaromatic heterocyclic groups.

The number of carbon atoms in the alkyl group is preferably from 1 to 8. A chain-like alkyl group is preferred to cyclic alkyl group. A straight-chain alkyl group is particularly preferred. The alkyl group preferably further has substituents (e.g., hydroxy group, carboxy group, alkoxy group, alkyl-substituted amino group). Examples of the alkyl group (including substituted alkyl group) include methyl group, ethyl group, n-butyl group, n-hexyl group, 2-hydroxyethyl group, 4-carboxybutyl group, 2-methoxyethyl group, and 2-diethylaminoethyl group.

The number of carbon atoms in the alkenyl group is preferably from 2 to 8. A chain-like alkinyl group is preferred to cyclic alkenyl group. A straight-chain alkenyl group is particularly preferred. The alkenyl group may further have substituents. Examples of the alkenyl group include vinyl group, allyl group, and 1-hexenyl group. The number of carbon atoms in the alkinyl group is preferably from 2 to 8. A chain-like alkinyl group is preferred to cyclic alkinyl group. A straight-chain alkinyl group is particularly preferred. The alkinyl group may further have substituents. Examples of the alkinyl group include ethinyl group, 1-butinyl group, and 1-hexinyl group.

The number of carbon atoms in the aliphatic acyl group is preferably from 1 to 10. Examples of the aliphatic acyl group include acetyl group, propanoyl group, and butanoyl group. The number of carbon atoms in the aliphatic acyloxy group is preferably from 1 to 10. Examples of the aliphatic acyloxy group include acetoxy group. The number of carbon atoms in the alkoxy group is preferably from 1 to 8. The alkoxy group may further has substituents (e.g., alkoxy group). Examples of the alkoxy group (including substituted alkoxy groups) include methoxy group, ethoxy group, butoxy group, and methoxyethoxy group. The number of carbon atoms in the alkoxycarbonyl group is preferably from 2 to 10. Examples of the alkoxycarbonyl group include methoxycarbonyl group, and ethoxycarbonyl group. The number of carbon atoms in the alkoxycarbonylamino group is preferably from 2 to 10. Examples of the alkoxycarbonylamino group include methoxycarbonylamino group, and ethoxycarbonylamino group.

The number of carbon atoms in the alkylthio group is preferably from 1 to 12. Examples of the alkylthio group include methylthio group, ethylthio group, and octylthio group. The number of carbon atoms in the alkylsulfonyl group is preferably from 1 to 8. Examples of the alkylsulfonyl group include methanesulfonyl group, and ethanesulfonyl group. The number of carbon atoms in the aliphatic amide group is preferably from 1 to 10. Examples of the aliphatic amide group include acetamide group. The number of carbon atoms in the aliphatic sulfonamide group is preferably from 1 to 8. Examples of the aliphatic sulfonamide group include methanesulfonamide group, butanesulfonamide group, and n-octanesulfonamide group. The number of carbon atoms in the aliphatic substituted amino group is preferably from 1 to 10. Examples of the aliphatic substituted amino group include dimethylamino group, diethylamino group, and 2-carboxyethylamino group.

The number of carbon atoms in the aliphatic substituted carbamoyl group is preferably from 2 to 10. Examples of the aliphatic substituted carbamoyl group include methylcarbamoyl group, and diethylcarbamoyl group. The number of carbon atoms in the aliphatic substituted sulfamoyl group is preferably from 1 to 8. Examples of the aliphatic substituted sulfamoyl group include methylsulfamoyl group, and diethylsulfamoyl group. The number of carbon atoms in the aliphatic substituted ureido group is preferably from 2 to 10. Examples of the aliphatic substituted ureido group include methylureido group. Examples of the nonaromatic heterocyclic group include piperidino group, and morpholino group. The molecular weight of the retardation developer is preferably from 300 to 800.

As the retardation adjustor to be used in the invention there may be used a rod-shaped compound having at least two aromatic rings. The aforementioned rod-shaped compound preferably has a linear molecular structure. The term “linear molecular structure” as used herein is meant to indicate that the molecular structure of the rod-shaped compound which is most thermodynamically stable is linear. The most thermodynamically stable structure can be determined by crystallographic structure analysis or molecular orbital calculation. For example, a molecular orbital calculation software (e.g., WinMOPAC2000, produced by Fujitsu Co., Ltd.) may be used to effect molecular orbital calculation, making it possible to determine a molecular structure allowing the minimization of heat formation of compound. The term “linear molecular structure” as used herein also means that the most thermodynamically stable molecular structure thus calculated forms a main chain at an angle of 140 degrees or more.

As the rod-shaped compound having at least two aromatic rings there is preferably used a compound represented by formula (I):
Ar¹-L¹-Ar² (I)
wherein Ar¹ and Ar² each independently represent an aromatic ring.

Examples of the aromatic ring employable herein include aryl groups (aromatic hydrocarbon group), substituted aryl groups, and substituted aromatic heterocyclic groups. The aryl group and substituted aryl group are preferred to the aromatic heterocyclic group and substituted aromatic heterocyclic group.

The heterocyclic group in the aromatic heterocyclic group is normally unsaturated. The aromatic heterocyclic group is preferably a 5-membered ring, 6-membered ring or 7-membered ring, more preferably a 5-membered ring or 6-membered ring. The aromatic heterocyclic group normally has the most numerous double bonds. The hetero atom is preferably nitrogen atom, oxygen atom or sulfur atom, more preferably nitrogen atom or sulfur atom. Preferred examples of the aromatic ring in the aromatic group include furane ring, thiophene ring, pyrrole ring, oxazole ring, isooxazole ring, thiazole ring, isothiazole ring, imidazole ring, pyrazole ring, furazane ring, triazole ring, pyrane ring, pyridine ring, pyridazine ring, pyrimidine ring, pyrazine ring, and 1,3,5-triazine ring.

Preferred examples of the aromatic ring in the aromatic group include benzene ring, furane ring, thiophene ring, pyrrole ring, oxazole ring, thiazole ring, imidazole ring, triazole ring, pyridine ring, pyrimidine ring, and pyrazine ring. Particularly preferred among these aromatic rings is benzene ring.

Examples of the substituents on the substituted aryl group and substituted aromatic heterocyclic group include halogen atoms (F, Cl, Br, I), hydroxyl groups, carboxyl groups, cyano groups, amino groups, alkylamino groups (e.g., methylamino group, ethylamino group, butylamino group, dimethylamino group), nitro groups, sulfo groups, carbamoyl groups, alkylcarbamoyl groups (e.g., N-methylcarbamoyl group, N-ethylcarbamoyl group, N,N-dimethylcarbamoyl group), sulfamoyl groups, alkylsulfamoyl groups (e.g., N-methylsulfamoyl group, N-ethylsulfamoyl group, N,N-dimethylsulfamoyl group), ureido groups, alkylureido groups (e.g., N-methylureido group, N,N-dimethylureido group, N,N,N′-trimethyl ureido group), alkyl groups (e.g., methyl group, ethyl group, propyl group, butyl group, pentyl group, heptyl group, octyl group, isopropyl group, s-butyl group, t-amyl group, cyclohexyl group, cyclopentyl group), alkenyl groups (e.g., vinyl group, allyl group, hexenyl group), alkinyl groups (e.g., ethinyl group, butinyl group), acyl groups (e.g., formyl group, acetyl group, butyryl group, hexanoyl group, lauryl group), acyloxy groups (e.g., acetoxy group, butyryloxy group, hexanoyloxy group, lauryloxy group), alkoxy groups (e.g., methoxy group, ethoxy group, propoxy group, butoxy group, pentyloxy group, heptyloxy group, octyloxy group), aryloxy groups (e.g., phenoxy group), alkoxycarbonyl groups (e.g., methoxycarbonyl group, ethoxycarbonyl group, propoxycarbonyl group, butoxycarbonyl group, pentyloxycarbonyl group, heptyloxycarbonyl group), aryloxycarbonyl groups (e.g., phenoxycarbonyl group), alkoxycarbonylamino groups (e.g., butoxycarbonylamino group, hexyloxycarbonylamino group), alkylthio groups (e.g., methylthio group, ethylthio group, propylthio group, butylthio group, pentylthio group, heptylthio group, octylthio group), arylthio groups (e.g., phenylthio group), alkylsulfonyl groups (e.g., methyl sulfonyl group, ethylsulfonyl group, propylsulfonyl group, butylsulfonyl group, pentylsulfonyl group, heptylsulfonyl group, octylsulfonyl group), amide groups (e.g., acetamide group, butylamide group, hexylamide group, laurylamide group), and nonaromatic heterocyclic groups (e.g., morpholyl group, pyradinyl group).

Examples of the substituents on the substituted aryl group and substituted aromatic heterocyclic group include halogen atoms, cyano groups, carboxyl groups, hydroxyl groups, amino groups, alkyl-substituted amino groups, acyl groups, acyloxy groups, amide groups, alkoxycarbonyl groups, alkoxy groups, alkylthio groups, and alkyl groups.

The alkyl moiety and alkyl group in the alkylamino group, alkoxycarbonyl group, alkoxy group and alkylthio group may further have substituents. Examples of the substituents on the alkyl moiety and alkyl group include halogen atoms, hydroxyl groups, carboxyl groups, cyano groups, amino groups, alkylamino groups, nitro groups, sulfo groups, carbamoyl groups, alkylcarbamoyl groups, sulfamoyl groups, alkylsulfamoyl groups, ureido groups, alkylureido groups, alkenyl groups, alkinyl groups, acyl groups, acyloxy groups, acylamino groups, alkoxy groups, aryloxy groups, alkoxycarbonyl groups, aryloxycarbonyl groups, alkylthio groups, arylthio groups, alkylsulfonyl groups, amide groups, and nonaromatic heterocyclic groups. Preferred among these substituents on the alkyl moiety and alkyl group are halogen atoms, hydroxyl groups, amino groups, alkylamino groups, acyl groups, acyloxy groups, acylamino groups, and alkoxy groups.

In formula (I), L¹ represents a divalent connecting group selected from the group consisting of groups composed of alkylene group, alkenylene group, alkynylene group, arylene group, —O—, —CO— and combination thereof.

The alkylene group may have a cyclic structure. The cyclic alkylene group is preferably cyclohexylene, particularly 1,4-cyclohexylene. As the chain-like alkylene group, a straight-chain alkylene is preferred to a branched alkylene. The number of carbon atoms in the alkylene group is preferably from 1 to 20, more preferably from 1 to 15, even more preferably from 1 to 10, even more preferably from 1 to 8, most preferably from 1 to 6.

The alkenylene group and alkynylene group preferably has a chain-like structure rather than cyclic structure, more preferably a straight-chain structure than branched chain-like structure. The number of carbon atoms in the alkenylene group and alkynylene group is preferably from 2 to 10, more preferably from 2 to 8, even more preferably from 2 to 6, even more preferably from 2 to 4, most preferably 2 (vinylene or ethinylene).

The number of carbon atoms in the arylene group is preferably from 6 to 20, more preferably from 6 to 16, even more preferably from 6 to 12.

L1 in the aforementioned formula (I) may be a divalent connecting group comprising these groups in combination. Examples of such a divalent connecting group will be given below.

L-1: —O—CO-alkylene group-CO—O—

L-2: —CO—O-alkylene group-O—CO—

L-3: —O—CO-alkenylene group-CO—O—

L-4: —CO—O-alkenylene group-O—CO—

L-5: —O—CO-alkynylene group-CO—O—

L-6: —CO—O-alkynylene group-O—CO—

L-7: —O—CO-arylene group-CO—O—

L-8: —CO—O-arylene group-O—CO—

L-9: —O—CO-arylene group-CO—O—

L-10: —CO—O-arylene group-O—CO—

In the molecular structure of formula (I), the angle formed by Ar¹ and Ar² with L¹ interposed therebetween is preferably 140 degrees or more.

The rod-shaped compound is more preferably a compound represented by the following formula (II):
Ar¹-L²-X-L³-Ar² (II)
wherein Ar¹ and Ar² each independently represent an aromatic group. The definition and examples of the aromatic group are similar to that of Ar¹ and Ar² in formula (I).

In formula (II), L² and L³ each independently represent a divalent connecting group selected from the group consisting of groups formed by alkylene group, —O—, —CO— and combination thereof. The alkylene group preferably has a chain-like structure rather than cyclic structure, more preferably a straight-chain structure rather than branched chain-like structure. The number of carbon atoms in the alkylene group is preferably from 1 to 10, more preferably from 1 to 8, even more preferably from 1 to 6, even more preferably from 1 to 4, most preferably 2 (methylene or ethylene).

L² and L³ each are preferably —O—CO— or —CO—O— in particular.

In formula (II), X represents 1,4-cyclohexylene, vinylene or ethinylene.

Specific examples of the compound represented by formula (I) or (II) will be given below.

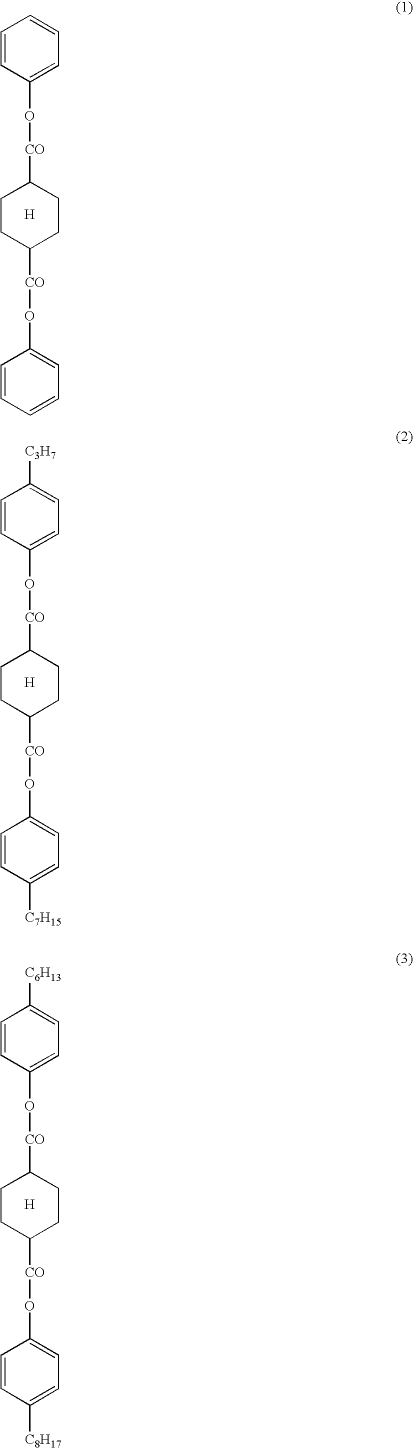

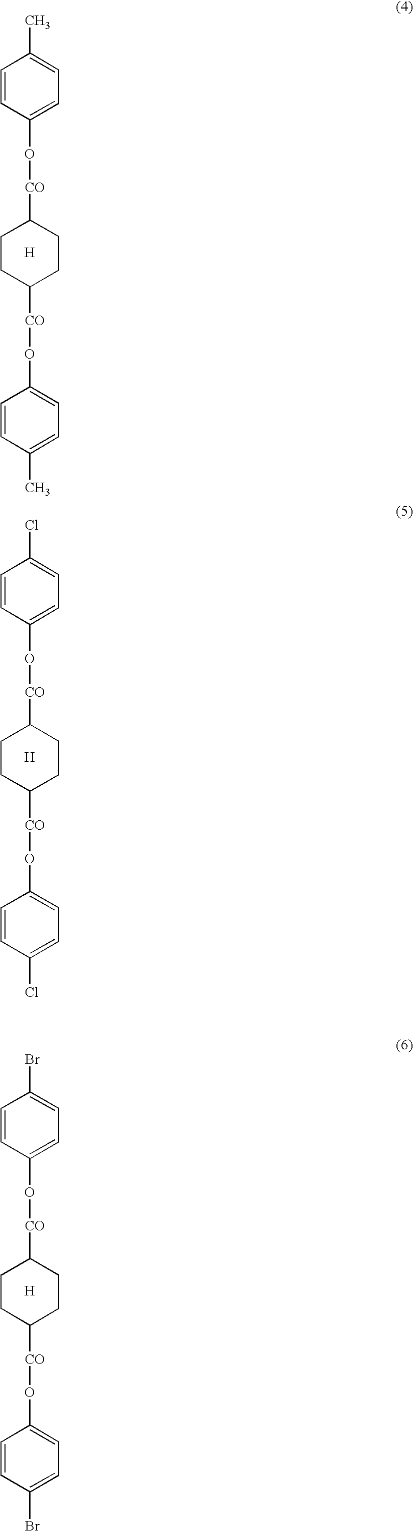

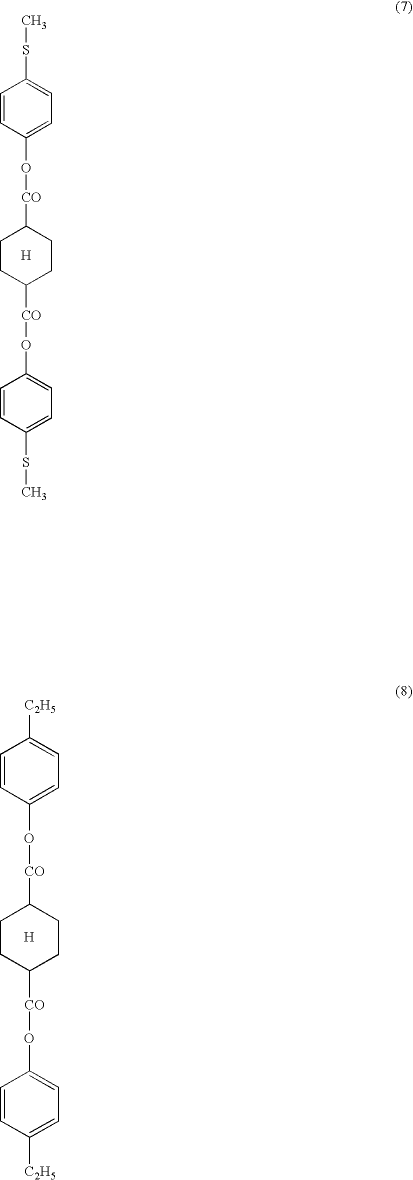

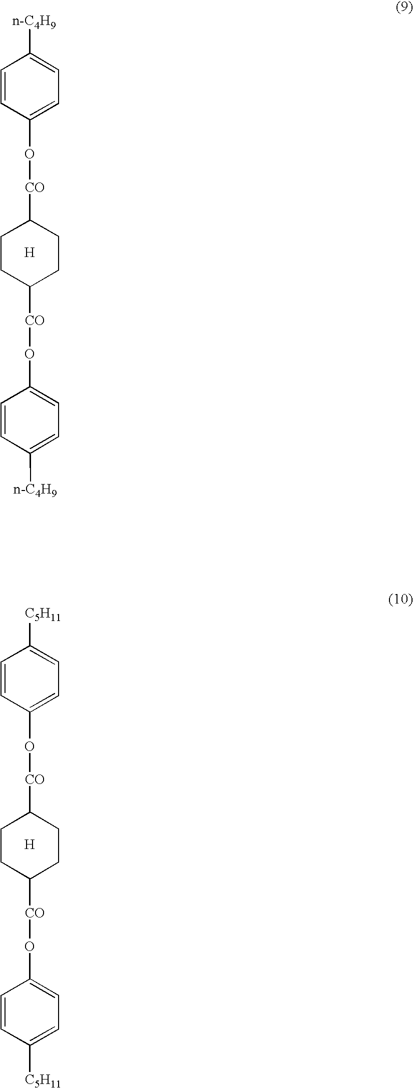

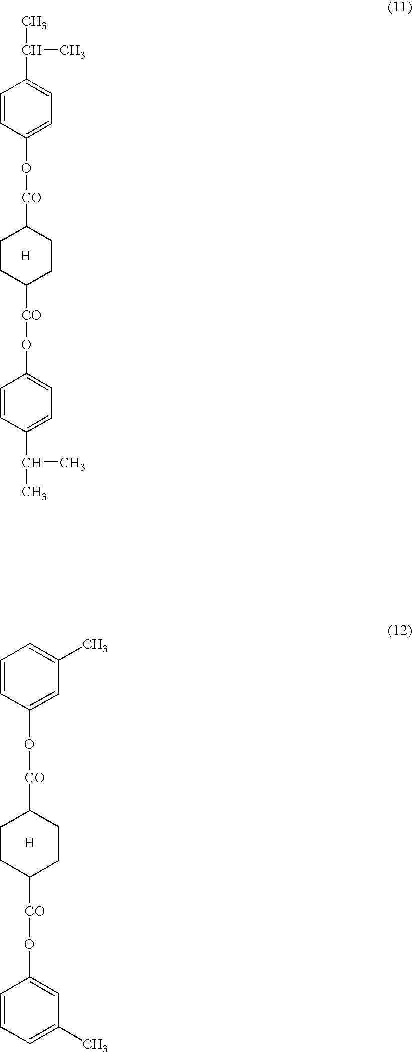

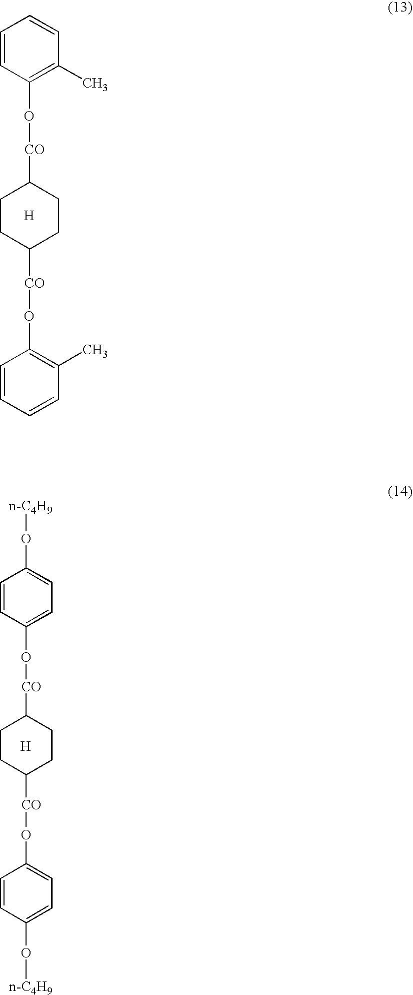

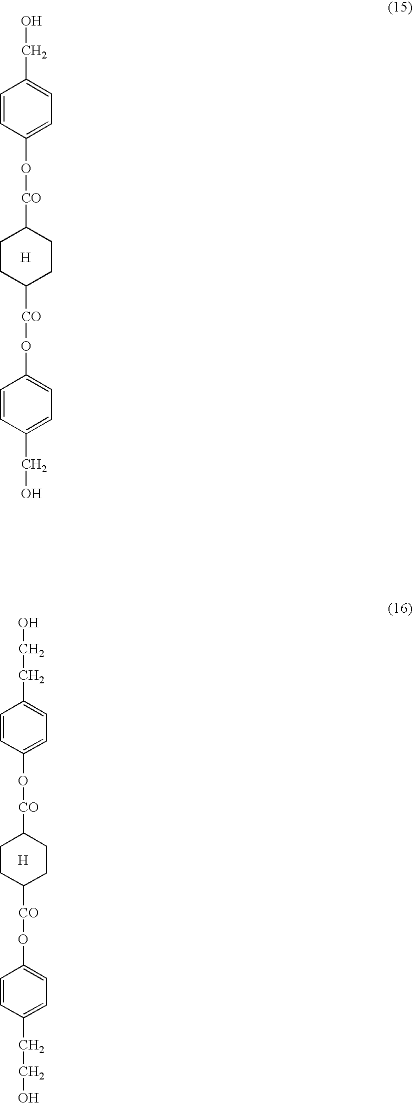

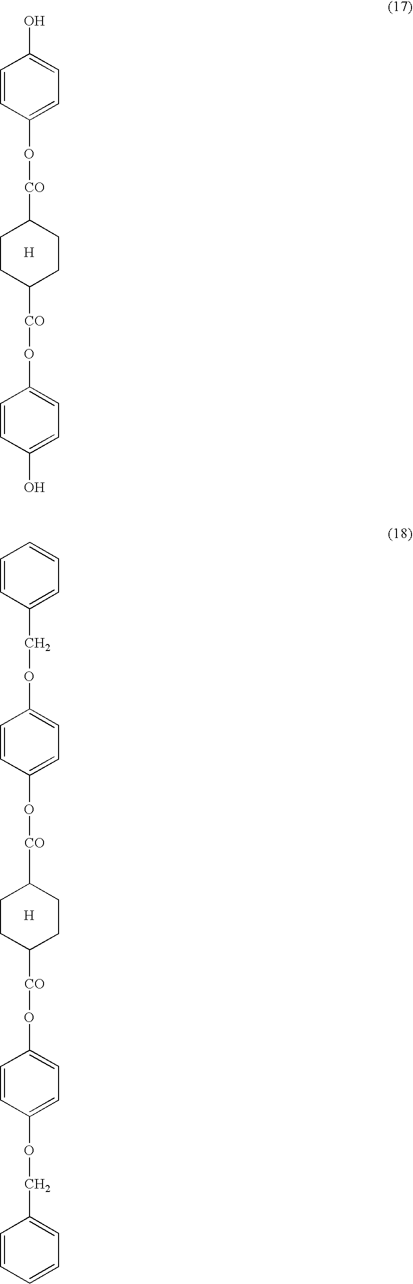

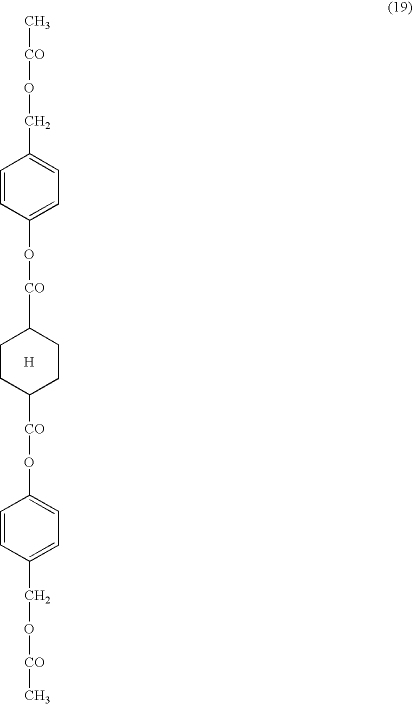

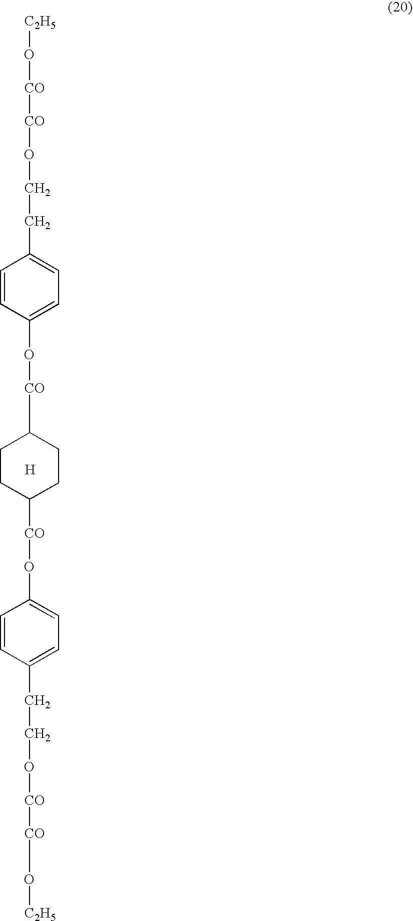

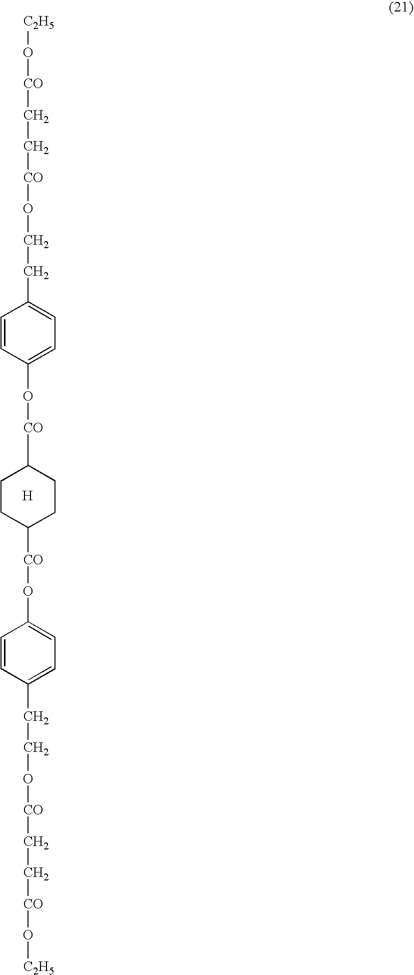

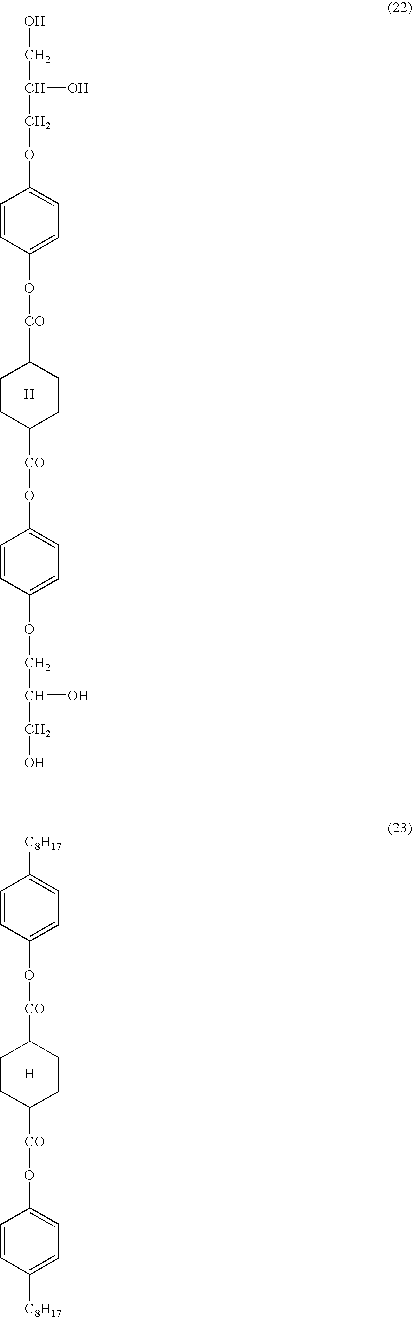

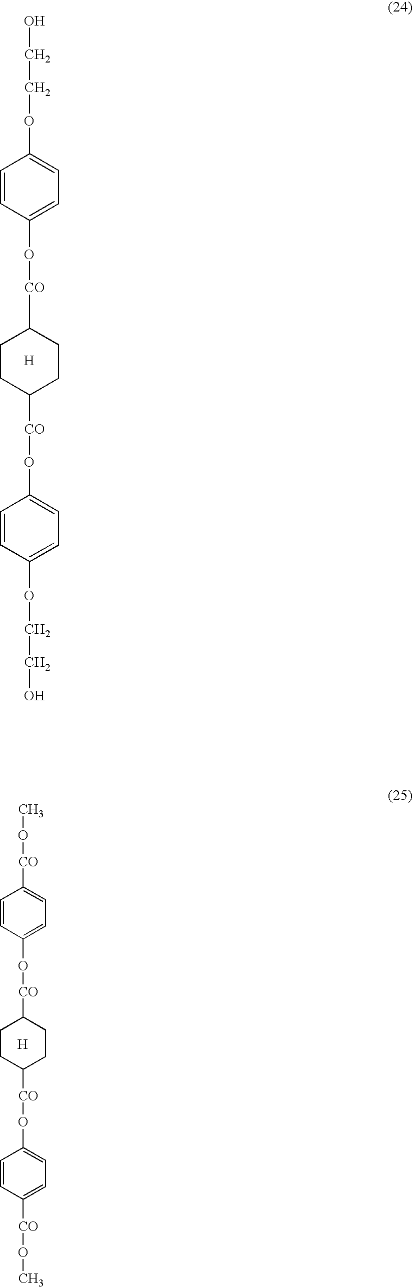

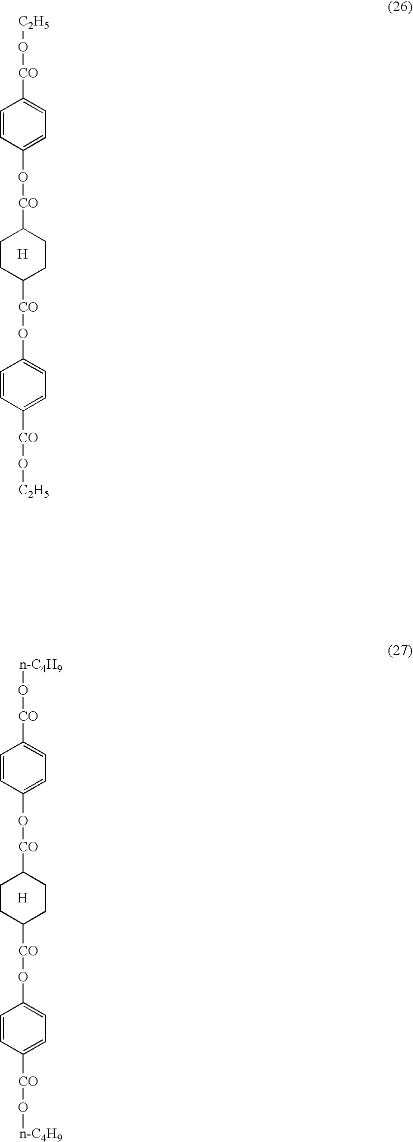

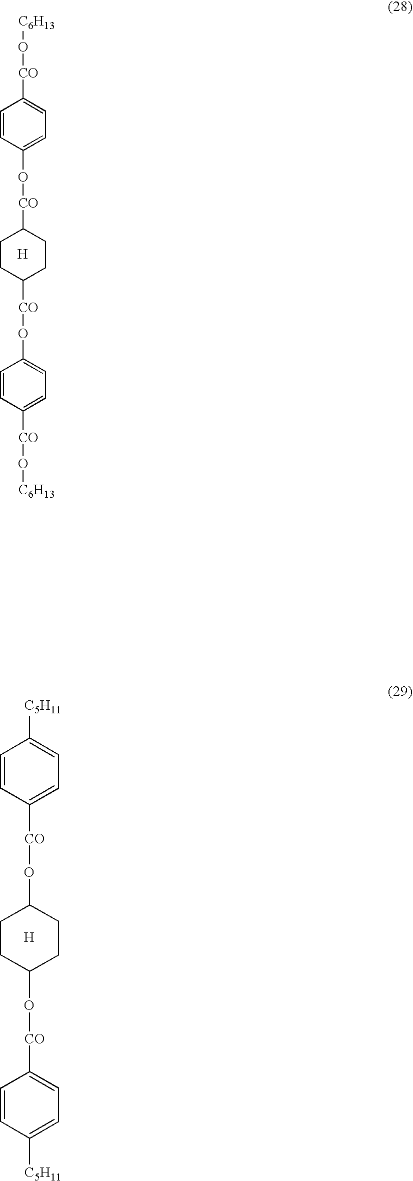

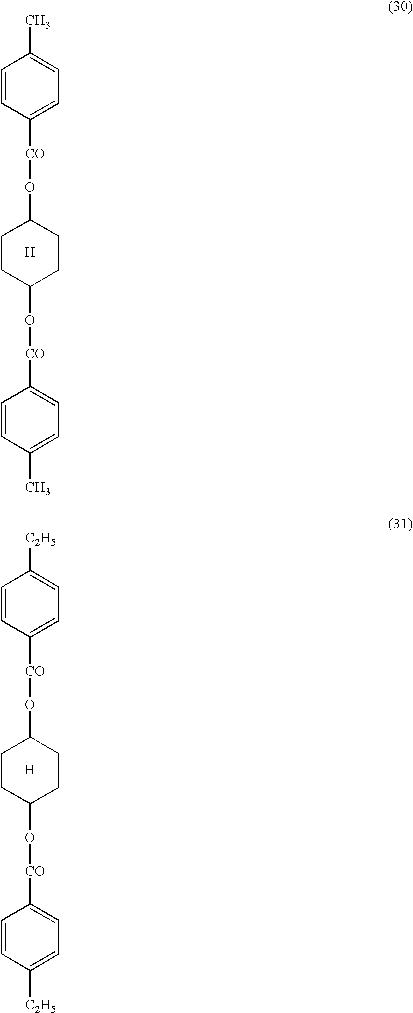

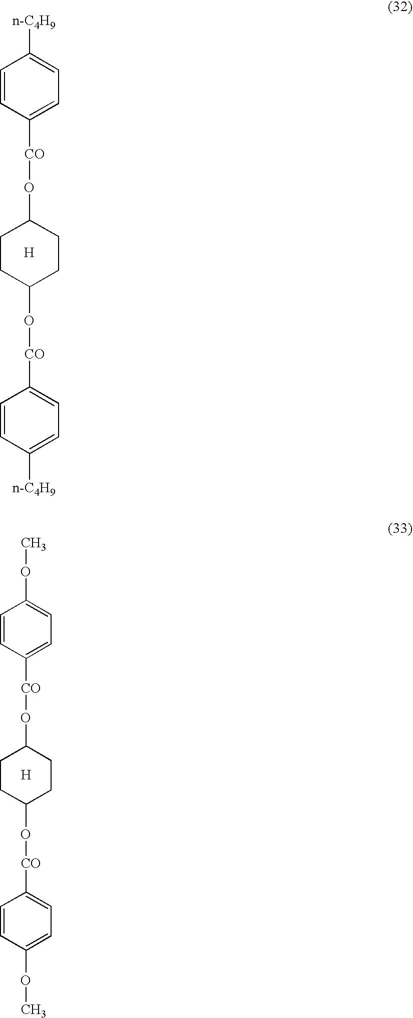

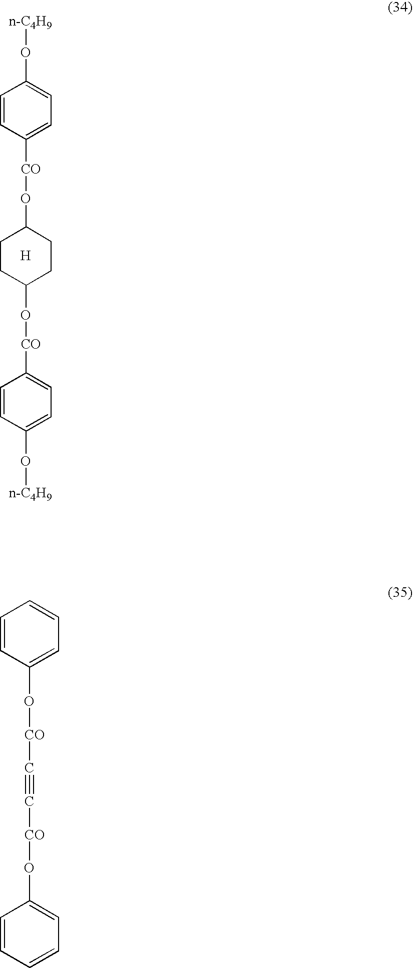

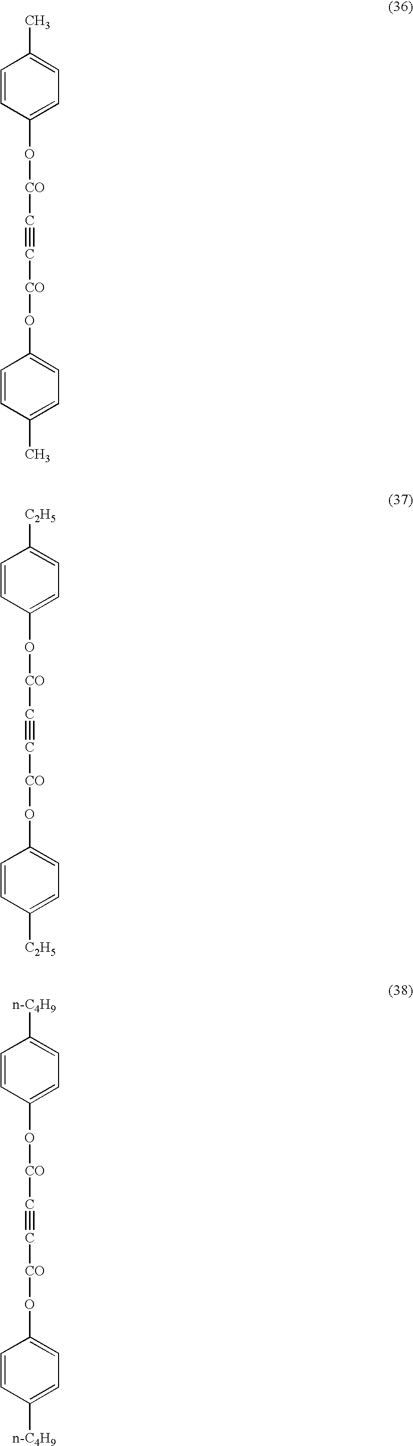

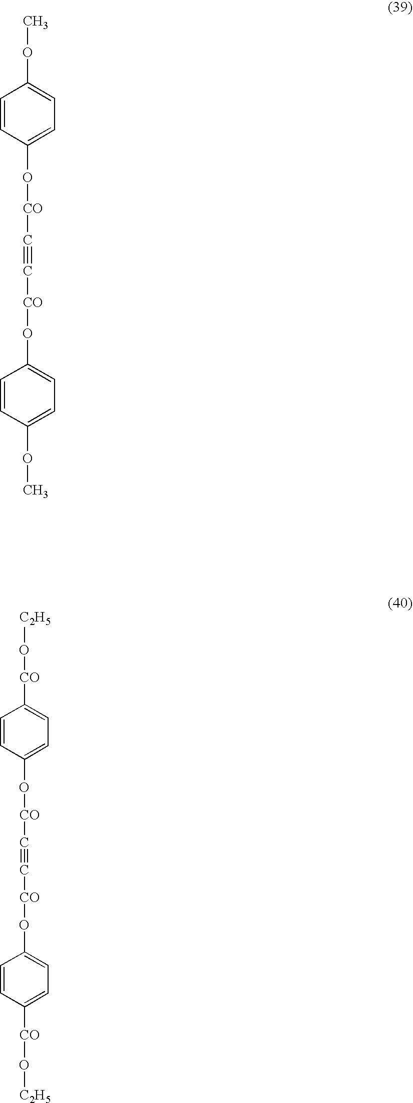

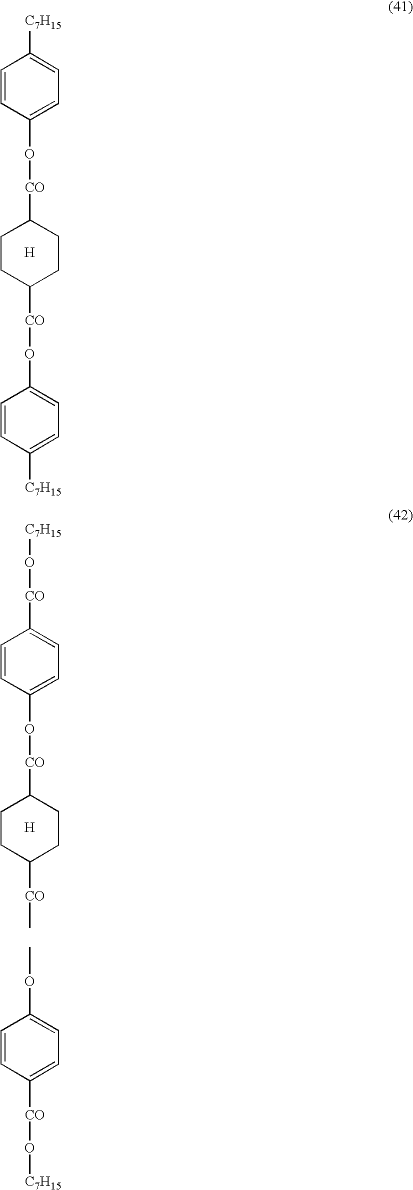

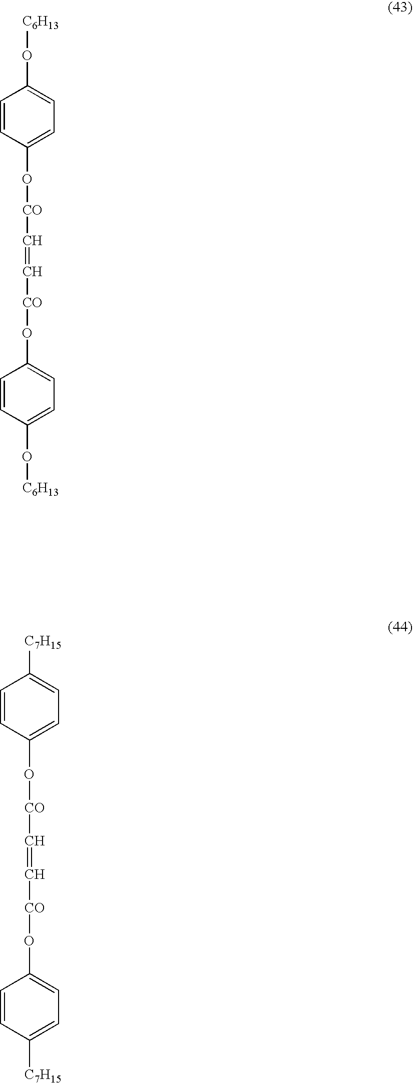

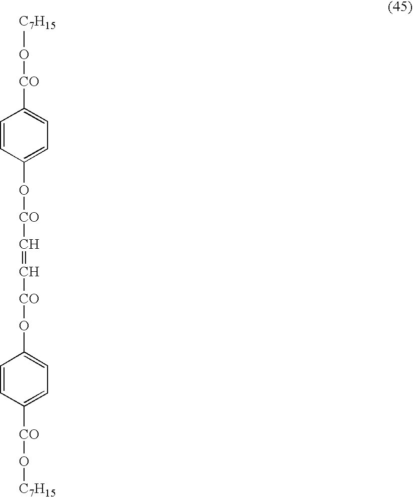

The specific examples (1) to (34), (41) and (42) each have two asymmetric carbon atoms in the 1-position and 4-position of cyclohexanone ring. However, the specific examples (1), (4) to (34), (41) and (42) each have a symmetric meso type molecular structure and thus has no optical isomers material (optical activity) but only geometrical isomers (trans type and cis type). Examples of trans type (1-trans) and cis type (1-cis) of the specific example (1) will be given below.

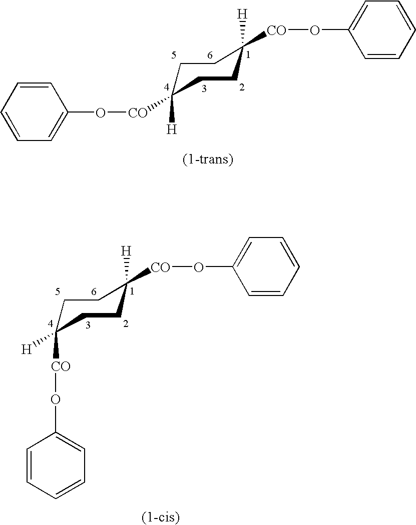

As previously mentioned, the rod-shaped compound preferably has a linear molecular structure. To this end, the trans type is preferred to the cis type.

The specific examples (2) and (3) each have optical isomers (four kinds of isomers in total) in addition to geometrical isomers. The trans type geometrical isomers are similarly preferred to the cis type geometrical isomers. There is nothing to choose among optical isomers. Any of D type optical isomer, L type optical isomer and racemate type optical isomer may be used.

In the specific examples (43) to (45), central vinylene bonds include trans type and cis type. For the same reason as mentioned above, the trans type vinylene bond is preferred to the cis type vinylene bond.

Other preferred examples of the rod-shaped compound will be given below.

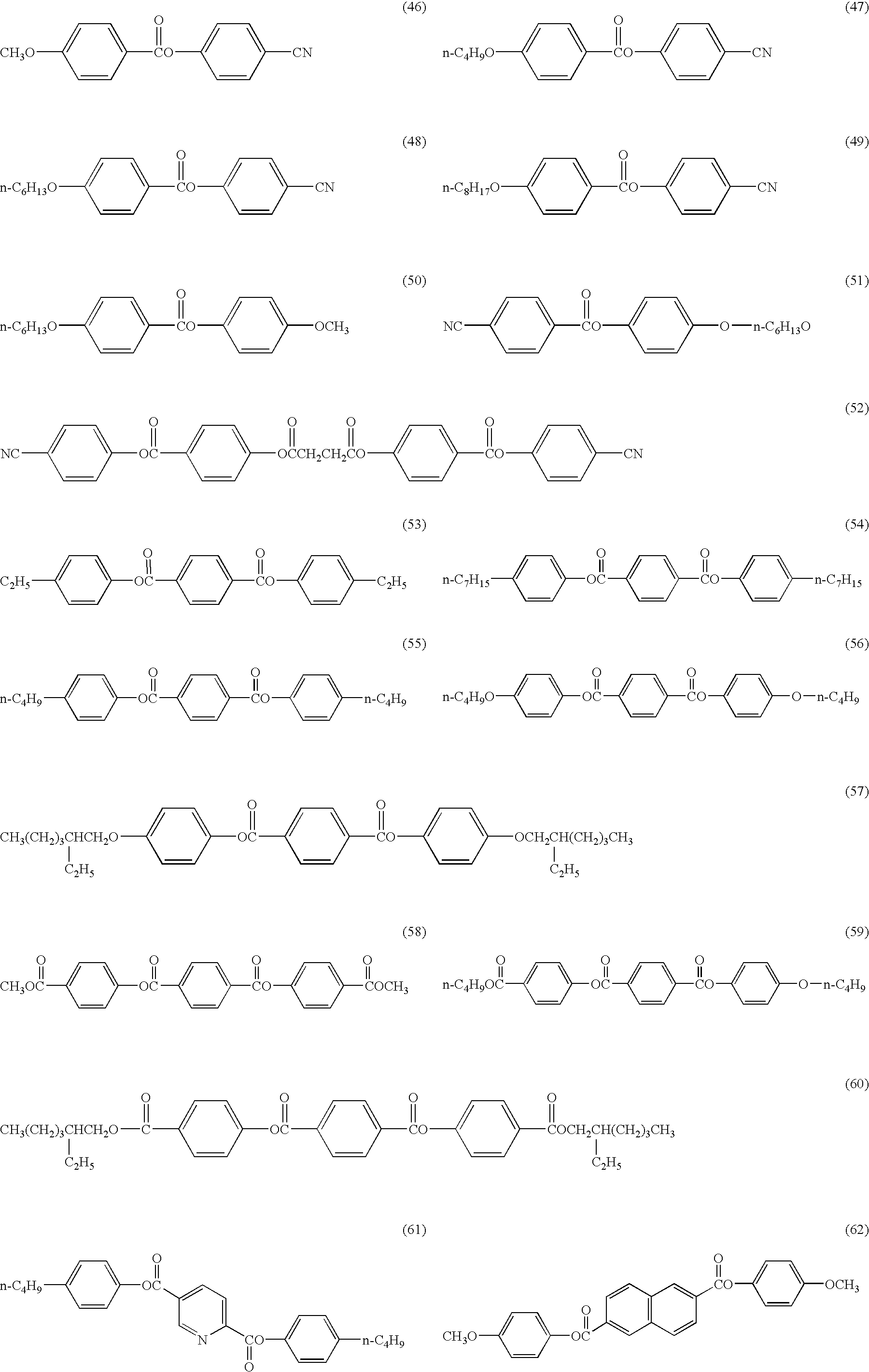

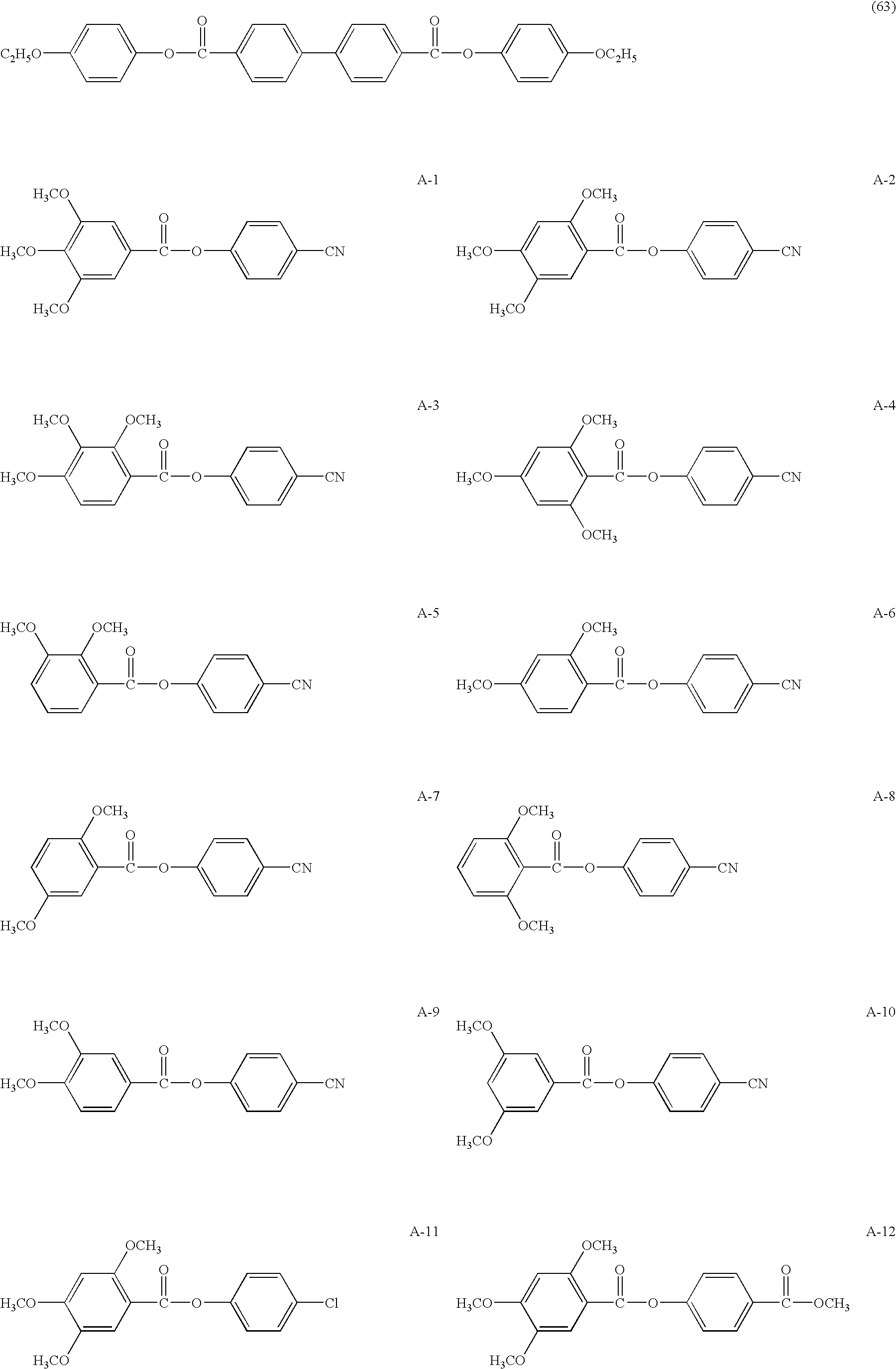

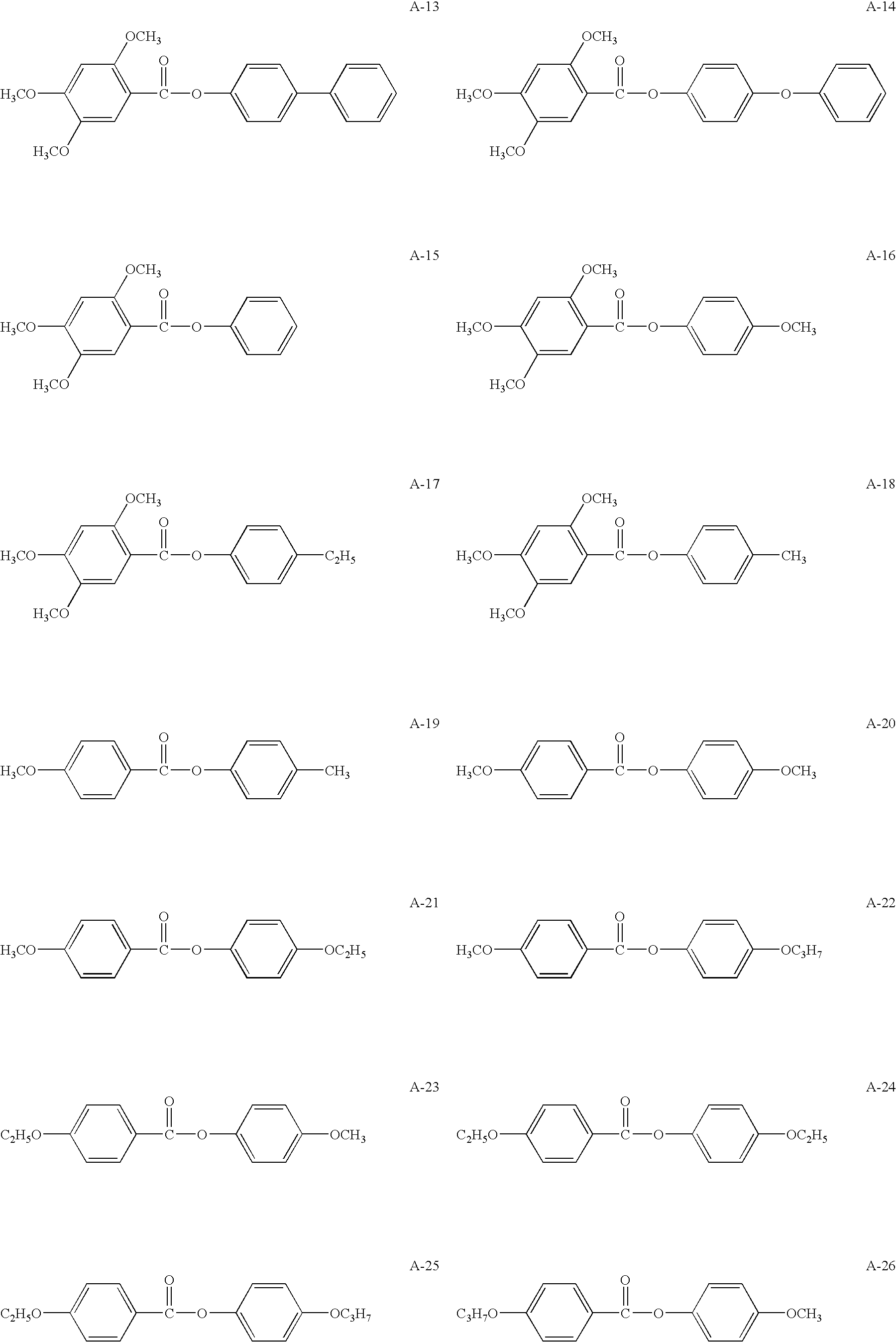

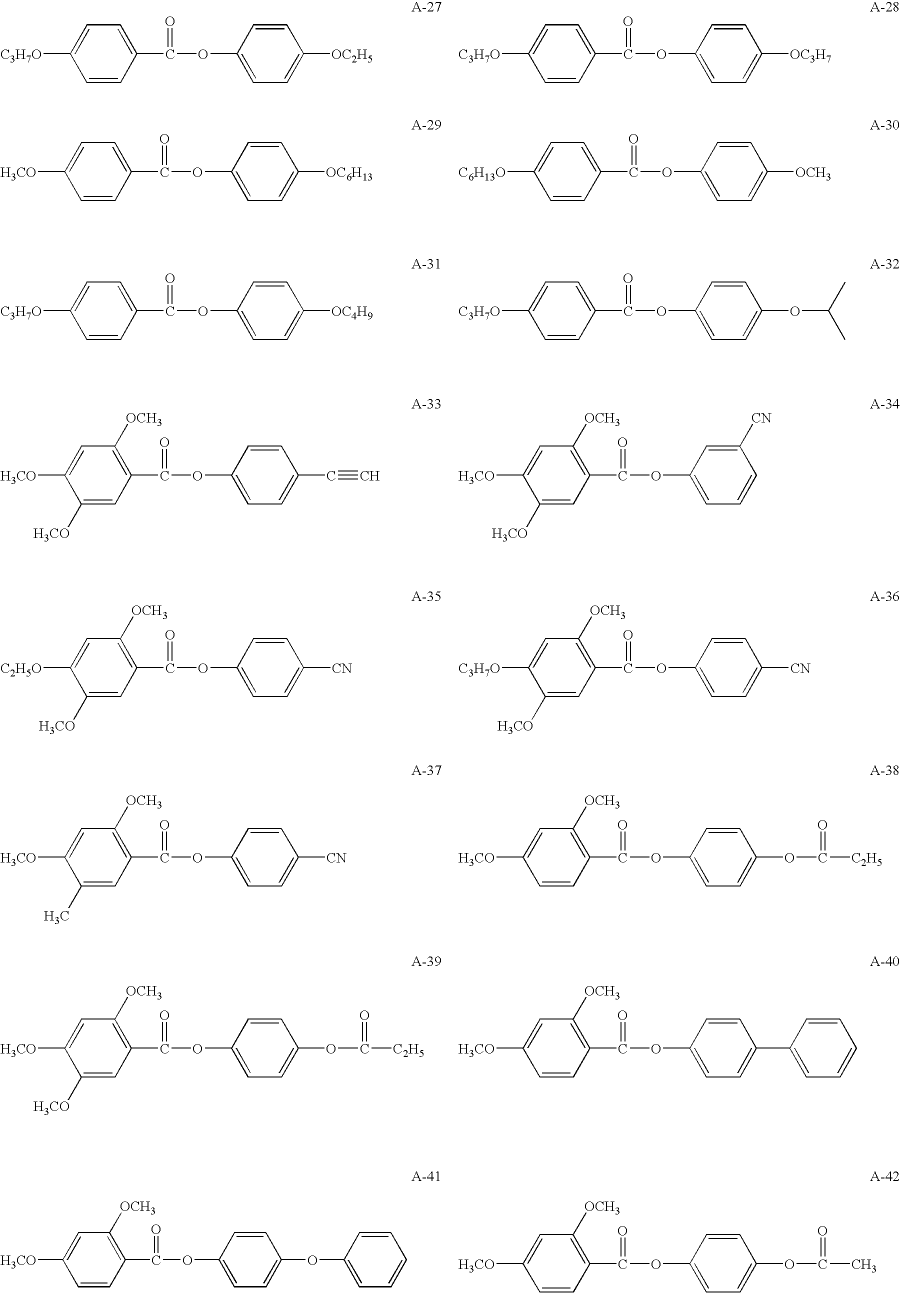

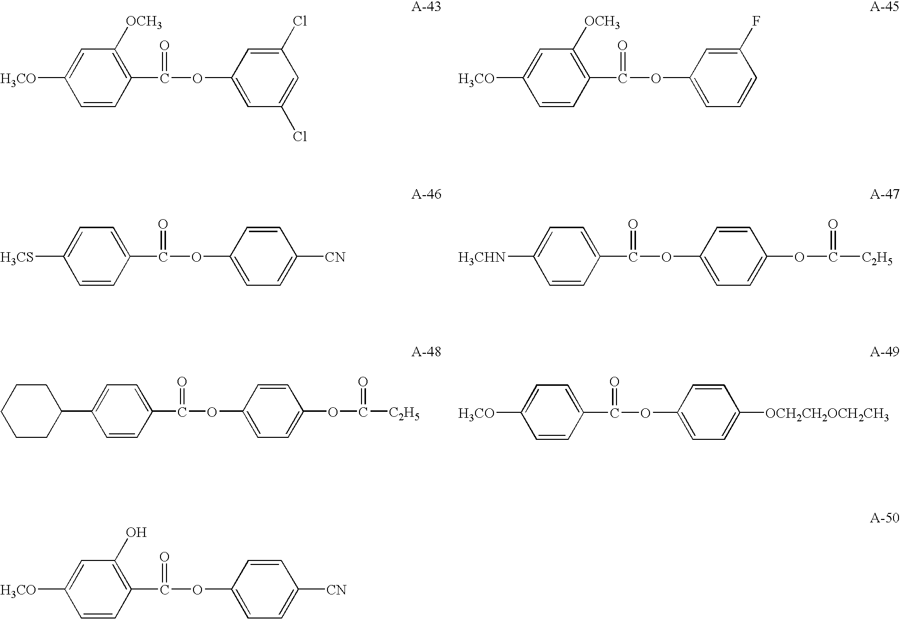

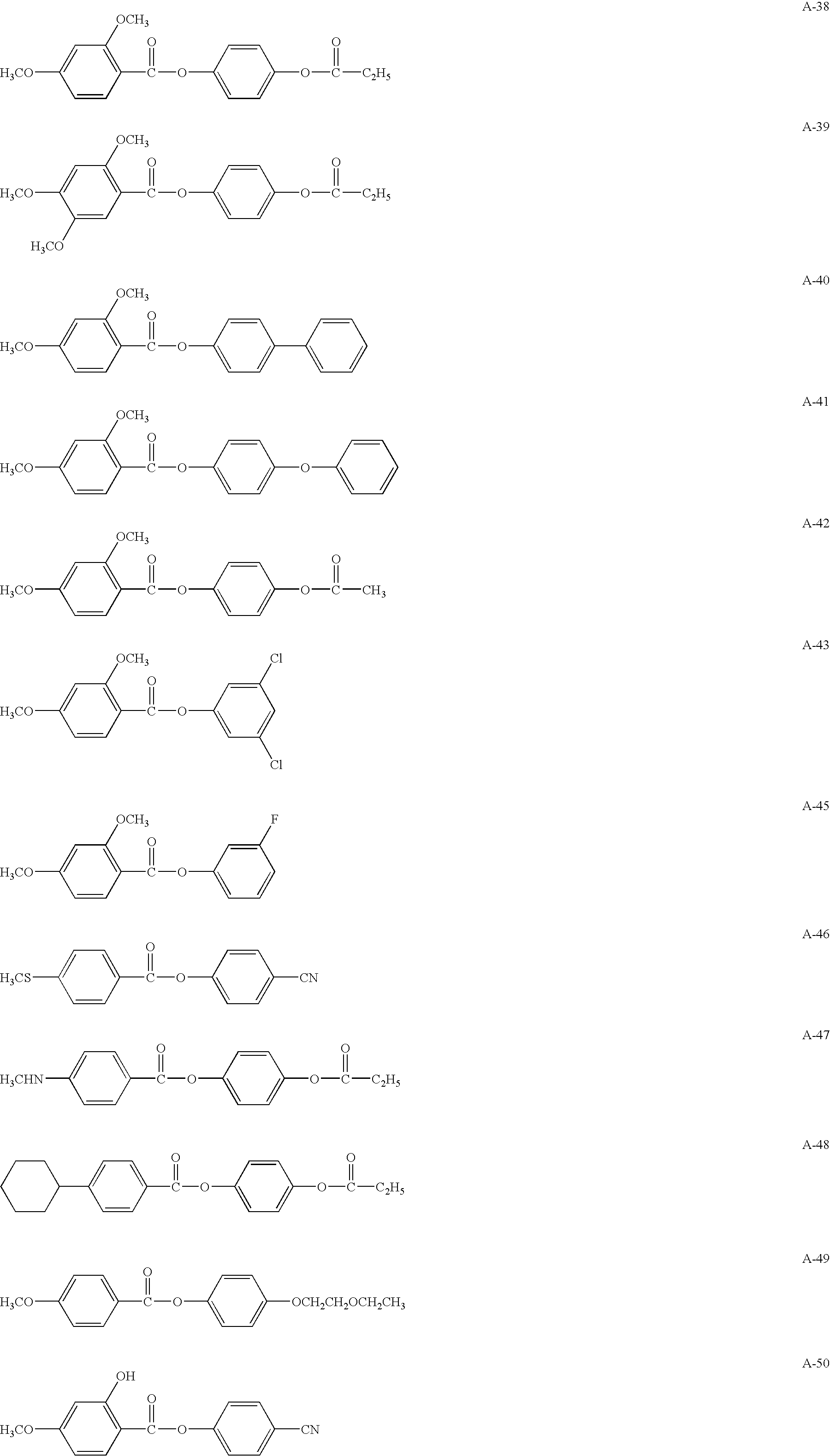

Two or more rod-shaped compounds having a maximum absorption wavelength (λmax) of shorter than 250 nm in the ultraviolet absorption spectrum of solution may be used in combination.

The rod-shaped compound can be synthesized by any method disclosed in literatures such as “Mol. Cryst. Liq. Cryst.”, vol. 53, page 229, 1979, “Mol. Cryst. Liq. Cryst.”, vol. 89, page 93, 1982, “Mol. Cryst. Liq. Cryst.”, vol. 145, page 11, 1987, “Mol. Cryst. Liq. Cryst.”, vol. 170, page 43, 1989, “J. Am. Chem. Soc.”, vol. 113, page 1,349, 1991, “J. Am. Chem. Soc.”, vol. 118, page 5,346, “J. Am. Chem. Soc.”, vol. 92, page 1,582, 1970, “J. Org. Chem.”, vol. 40, page 420, 1975, and “Tetrahedron”, vol. 48, No. 16, page 3,437, 1992.

The aromatic compound is preferably used in an amount of from 0.01 to 20 parts by weight, more preferably from 1 to 20 parts by weight based on 100 parts by weight of cellulose acylate. Two or more aromatic compounds may be used in combination.

(Production of Cellulose Acylate Film)

For the production of the aforementioned cellulose acylate film, any ordinary method of preparing a cellulose acylate film may be used. In particular, a solvent casting method is preferably used. In the solvent casting method, a solution (dope) having a cellulose acylate dissolved in an organic solvent may be used to produce a film.

The preferred examples of the organic solvent employable herein include those selected from the group consisting of C₃-C₁₂ ethers, C₃-C₁₂ ketones, C₃-C₁₂ esters and C₁-C₆ halogenated hydrocarbons. These ethers, ketones and esters may have a cyclic structure. A compound having two or more of the functional groups of ether, ketone and ester (i.e., —O—, —CO— and —COO—) may be used as an organic solvent. The organic solvent may have other functional groups such as alcohol-based hydroxyl group. The number of carbon atoms in the organic solvent having two or more functional groups may fall within the range defined for compound having any of these functional groups.

Examples of the C₃-C₁₂ ethers include diisopropyl ether, dimethoxymethane, 1,4-dioxane, 1,3-dioxolane, tetrahydrofurane, anisole, and phenethol.

Examples of the C₃-C₁₂ ketones include acetone, methyl ethyl ketone, diethyl ketone, diisobutyl ketone, cyclohexanone, and methyl cyclohexanone.

Examples of the C₃-C₁₂ esters include methyl formate, propyl formate, pentyl formate, methyl acetate, ethyl acetate, and pentyl acetate.

Examples of the organic solvent having two or more functional groups include 2-ethoxyethyl acetate, 2-methoxyethanol, and 2-butoxyethanol.

The number of carbon atoms in the halogenated hydrocarbon is preferably from 1 or 2, most preferably 1. The halogen in the halogenated hydrocarbon is preferably chlorine. The proportion of hydrogen atoms in the halogenated hydrocarbon substituted by halogen is preferably from 25 to 75 mol-%, more preferably from 30 to 70 mol-%, even more preferably from 35 to 65 mol-%, most preferably from 40 to 60 mol-%. Methylene chloride is one of typical halogenated hydrocarbons.

Two or more organic solvents may be used in admixture.

The cellulose acylate solution may be prepared by any ordinary method. The term “ordinary method” as used herein is meant to indicate that the processing is effected at a temperature of not lower than 0° C. (ordinary temperature or high temperature). For the preparation of the solution, the method and apparatus of producing a dope in ordinary solvent casting method may be used. In the case of ordinary method, as an organic solvent there is preferably used a halogenated hydrocarbon (particularly methylene chloride).

The content of cellulose acylate is adjusted such that the cellulose acylate is incorporated in the resulting solution in an amount of from 10 to 40% by weight, preferably from 10 to 30% by weight. The organic solvent (main solvent) may comprise arbitrary additives described later incorporated therein.

The cellulose acylate solution can be prepared by stirring the cellulose acylate and the organic solvent at ordinary temperature (from 0 to 40° C.). A high concentration solution may be stirred under pressure and heating. In some detail, the cellulose acylate and the organic solvent are sealed in a pressure vessel. The mixture is then heated to a temperature of not lower than the boiling point of the solvent at ordinary temperature within the range in which the solvent doesn't boil under pressure with stirring. The heating temperature is normally 40° C. or more, preferably from 60 to 200° C., more preferably from 80 to 110° C.

The various components may be previously roughly mixed before being put in the vessel. Alternatively, these components may be sequentially put in the vessel. It is necessary that the vessel be formed so as to allow stirring. An inert gas such as nitrogen gas may be injected into the vessel to raise the pressure in the vessel. The rise of the vapor pressure of the solvent by heating may be utilized. Alternatively, the sealing of the vessel may be followed by the addition of the various components under pressure.

In the case where the components are heated, the vessel may be externally heated. For example, a jacket type heating device may be used. Alternatively, a plate heater may be provided outside the vessel so that the heated liquid is circulated through a piping provided on the vessel to heat the entire vessel.

The mixture is preferably stirred by an agitating blade provided inside the vessel. The agitating blade preferably has a length such that it reaches near the wall of the vessel. The agitating blade is preferably terminated by a scraper blade to renew the liquid layer on the wall of the vessel.

The vessel may have instruments such as pressure gauge and thermometer provided therein. The various components are dissolved in a solvent in the vessel. The dope thus prepared is cooled, and then withdrawn from the vessel. Alternatively, the dope thus prepared is withdrawn from the vessel, and then cooled by a heat exchanger or the like.

The solution may be prepared by a cold dissolution method. In the cold dissolution method, the cellulose acylate can be dissolved even in an organic solvent in which the cellulose acylate can be difficultly dissolved by ordinary dissolution methods. Even if a solvent in which the cellulose acylate can be dissolved by ordinary methods is used, the cold dissolution method can exert an effect of rapidly obtaining a uniform solution.

In the cold dissolution method, the cellulose acylate is gradually added to the organic solvent at room temperature with stirring. The content of the cellulose acylate is preferably adjusted such that the cellulose acylate is incorporated in the mixture in an amount of from 10 to 40% by weight, preferably from 10 to 30% by weight. The mixture may further comprise arbitrary additives described later incorporated therein.

Subsequently, the mixture is cooled to a temperature of from −100° C. to −10° C. (preferably from −80° C. to −10° C., more preferably from −50° C. to −20° C., most preferably from −50° C. to −30° C.). The cooling of the mixture may be effected in a dry ice-methanol bath (−75° C.) or a chilled diethylene glycol solution (−30° C. to −20° C.). In this manner, the mixture of cellulose acylate and organic solvent is solidified.

The cooling rate is preferably 4° C./min or more, more preferably 8° C./min or more, most preferably 12° C./min or more. The cooling rate is preferably as high as possible. However, the theoretical upper limit of the cooling rate is 10,000° C./sec. The technical upper limit of the cooling rate is 1,000° C./sec. The practical upper limit of the cooling rate is 100° C./sec. The cooling rate is obtained by dividing the difference between the temperature at which cooling begins and the final cooling temperature by the duration between the time at which cooling begins and the time at which the final cooling temperature is reached.

Further, when the mixture thus solidified is heated to a temperature of from 0° C. to 200° C. (preferably from 0° C. to 150° C., more preferably from 0° C. to 120° C., most preferably from 0° C. to 50° C.), the cellulose acylate is dissolved in the organic solvent. The temperature rise may be carried out by allowing the mixture to stand at room temperature or by heating the mixture over a hot bath. The heating rate is preferably 4° C./min or more, more preferably 8° C./min or more, most preferably 12° C./min or more. The heating rate is preferably as high as possible. The theoretical upper limit of the heating rate is 10,000° C./sec. The technical upper limit of the heating rate is 1,000° C./sec. The practical upper limit of the heating rate is 100° C./sec. The heating rate is obtained by dividing the difference between the temperature at which heating begins and the final heating temperature by the duration between the time at which heating begins and the time at which the final heating temperature is reached.

In this manner, a uniform solution is obtained. In the case where dissolution has been insufficiently made, cooling and heating may be repeated. Whether or not dissolution has been insufficiently made can be judged merely by visually observing the external appearance of the solution.

In the cold dissolution method, a sealable vessel is preferably used to avoid the entrance of water content due to moisture condensation. By effecting cooling step under pressure and heating step under reduced pressure, the dissolution time can be reduced. In order to raise and reduce the pressure, a pressure-resistant vessel is preferably used.

The 20 wt-% solution having a cellulose acylate (acetylation degree: 60.9%; viscosity-average polymerization degree: 299) dissolved in methyl acetate by a cold dissolution method shows a quasi-phase transition point between sol and gel at around 33° C. and becomes uniform gel at a temperature of not higher than 33° C. Accordingly, this solution needs to be stored at a temperature of not lower than the quasi-phase transition temperature, preferably a temperature of about 10° C. higher than the gel phase transition temperature. However, the quasi-phase transition temperature varies with the acylation degree and viscosity-average polymerization degree of cellulose acylate, the concentration of the solution or the organic solvent used.

The cellulose acylate solution (dope) thus prepared can be then subjected to solvent casting to produce a cellulose acylate film.

The dope thus prepared is casted over a drum or band so that the solvent is evaporated to form a film. The dope to be casted is preferably adjusted in its concentration such that the solid content is from 18 to 35% by weight. The surface of the drum or band is preferably previously mirror-like finished. For the details of casting and drying in the solvent casting method, reference can be made to U.S. Pat. No. 2,336,310, U.S. Pat. No. 2,367,603, U.S. Pat. No. 2,492,078, U.S. Pat. No. 2,492,977, U.S. Pat. No. 2,492,978, U.S. Pat. No. 2,607,704, U.S. Pat. No. 2,739,069, U.S. Pat. No. 2,739,070, British Patent 640,731, British Patent 736,892, JP-B-45-4554, JP-A-49-5614, JP-A-60-176834, JP-A-60-203430, and JP-A-62-115035.

The dope is preferably casted onto a drum or band having a surface temperature of 10° C. or less. The dope thus casted is preferably dried with an air wind for 2 or more seconds. The film thus obtained is peeled off the drum or band, and then optionally dried with a hot air wind having a successive temperature change from 100° C. to 160° C. so that the residual solvent is evaporated. For the details of this method, reference can be made to JP-B-5-17844. In this manner, the time between casting and peeling can be reduced. In order to execute this method, it is necessary that the dope undergo gelation at the surface temperature of the drum or band during casting.

The cellulose acylate film may comprise a plasticizer incorporated therein to enhance the mechanical properties or drying rate thereof. As such a plasticizer there may be used a phosphoric acid ester or carboxylic acid ester. Examples of the phosphoric acid ester include triphenyl phosphate (TPP), and tricresyl phosphate (TCP). Representative examples of the carboxylic acid ester include phthalic acid ester, and citric acid ester. Examples of the phthalic acid ester include dimethyl phthalate (DMP), diethyl phthalate (DEP), dibutyl phthalate (DBP), dioctyl phthalate (DOP), diphenyl phthalate (DPP), and diethylhexyl phthalate (DEHP). Examples of the citric acid ester include triethyl O-acetylcitrate (OACTE), and tributyl O-acetylcitrate (OACTB). Other examples of carboxylic acid ester include butyl oleate, methylacetyl ricinoleate, dibutyl sebacate, and various trimellitic acid esters. A phthalic acid ester-based plasticizer (e.g., DMP, DEP, DBP, DOP, DPP, DEHP) is preferably used. DEP and DPP are particularly preferred.

The amount of the plasticizer to be incorporated is preferably from 0.1 to 25% by weight, more preferably from 1 to 20% by weight, most preferably from 3 to 15% by weight based on the amount of the cellulose acylate.

The cellulose acylate film may comprise a deterioration inhibitor (e.g., oxidation inhibitor, peroxide decomposer, radical inhibitor, metal inactivator, acid trapping agent, amine) incorporated therein. For the details of these deterioration inhibitors, reference can be made to JP-A-3-199201, JP-A-5-1907073, JP-A-5-194789, JP-A-5-271471, and JP-A-6-107854. In order to exert the effect of the deterioration inhibitor and inhibit the bleed out of the deterioration inhibitor to the surface of the film, the amount of the deterioration inhibitor to be incorporated is preferably from 0.01 to 1% by weight, more preferably from 0.01 to 0.2 parts by weight based on the amount of the solution (dope) to be prepared. Particularly preferred examples of the deterioration inhibitor include butyrated hydroxytoluene, and tribenzylamine (TBA).

(Stretching of Cellulose Acylate Film)

The cellulose acylate film may be stretched to adjust the retardation value thereof. The draw ratio is preferably from 3 to 100%.

As the stretching method there may be used any existing method without departing from the aforementioned scope of the invention. From the standpoint of in-plane uniformity, tenter stretching is particularly preferred. The cellulose acylate film of the invention preferably has a width of at least 100 cm. The dispersion of Re value over the total width is preferably ±5 nm, more preferably ±3 nm. The dispersion of Rth value over the total width is preferably ±10 nm, more preferably ±5 nm. The dispersion of Re value and Rth value over the length preferably fall within the range of crosswise dispersion.

The stretching may be effected in the course of filming step. Alternatively, the raw fabric of film wound may be subjected to stretching. In the former case, the film may be stretched while retaining residual solvent therein. When the content of residual solvent is from 2 to 30%, stretching can be fairly effected. During this procedure, the film is preferably stretched in the direction perpendicular to the longitudinal direction while being conveyed in the longitudinal direction so that the slow axis of the film is aligned perpendicular to the longitudinal direction of the film.

The stretching temperature conditions can be properly predetermined depending on the amount of residual solvent and the thickness of the film to be stretched. In the case where the film is stretched while retaining residual solvent, the film thus stretched is preferably dried. In order to dry the film thus stretched, the method described with reference to the preparation of film may be used.

The thickness of the cellulose acylate film thus stretched is 180 μm or less, preferably from 40 to 180 μm, more preferably from 60 to 110 μm, most preferably from 80 to 110 μm. The above defined range of thickness corresponds to the thickness of the optical compensation sheet.

(Surface Treatment of Cellulose Acylate Film)

In the case where the optical compensation sheet made of the aforementioned cellulose acylate film is used as a transparent protective film for polarizing plate, the cellulose acylate film is preferably subjected to surface treatment.

Examples of the surface treatment to be effected herein include corona discharge treatment, glow discharge treatment, flame treatment, acid treatment, alkaline treatment, and ultraviolet irradiation. Particularly preferred among these surface treatments is acid treatment or alkaline treatment, i.e., saponification of cellulose acylate.

The cellulose acylate film as mentioned above acts as an optical compensation sheet even when used only in a sheet.

(Polarizing Plate)

The polarizing plate comprises a polarizing film and two transparent protective films disposed on the respective side of the polarizing film. In the invention, as at least one of the two protective films there is used an optical compensation sheet of the aforementioned cellulose acylate film. The other protective film may be an ordinary cellulose acylate film.

Examples of the polarizing film include iodine-based polarizing film, dye-based polarizing film containing dichromatic dye, and polyester-based polarizing film. The iodine-based polarizing film and dye-based polarizing film are normally prepared from a polyvinyl alcohol-based film.

The slow axis of the optical compensation sheet and the transmission axis of the polarizing film are preferably aligned substantially parallel to each other.

(Anti-Reflection Layer)

The transparent protective film disposed on the side of the polarizing plate opposite the liquid crystal cell preferably has an anti-reflection layer provided thereon. In particular, in the invention, an anti-reflection layer (i) including a light-scattering layer and a lower refractive layer stacked on a transparent protective film in this order or an anti-reflection layer (ii) including a middle refractive layer, a higher refractive layer and a lower refractive layer stacked on a protective film in this order is preferably used. Preferred examples of such an anti-reflection layer will be given below.

A preferred example of the anti-reflection layer (i) including a light-scattering layer and a lower refractive layer provided on a protective film will be described below.

The light-scattering layer of the invention preferably has a particulate mat dispersed therein. The refractive index of the material of the light-scattering layer other than the particulate mat is preferably from 1.48 to 2.00. The refractive index of the lower refractive layer is preferably from 1.20 to 1.49. In the invention, the light-scattering layer has both anti-glare properties and hard coating properties. The light-scattering layer may be formed by a single layer or a plurality of layers such as two to four layers.

The anti-reflection layer is preferably designed in its surface roughness such that the central line average roughness Ra is from 0.08 to 0.40 μm, the ten point averaged roughness Rz is 10 times or less Ra, the average distance between mountain and valley Sm is from 1 to 100 μm, the standard deviation of the height of mountains from the deepest portion in roughness is 0.5 μm or less, the standard deviation of the average distance between mountain and valley Sm with central line as reference is 20 μm or less and the proportion of the surface having an inclination angle of from 0 to 5 degrees is 10% or less, making it possible to attain sufficient anti-glare properties and visually uniform matte finish. Further, when the tint of reflected light under C light source comprises a* value of −2 to 2 and b* value of −3 to 3 and the ratio of minimum reflectance to maximum reflectance at a wavelength of from 380 nm to 780 nm is from 0.5 to 0.99, the tint of reflected light is neutral to advantage. Moreover, when the b* value of transmitted light under C light source is predetermined to range from 0 to 3, the yellow tint of white display for use in display devices is reduced to advantage. Further, when a lattice of having a size of 120 μm×40 μm is disposed interposed between the planar light source and the anti-reflection film of the invention so that the standard deviation of brightness distribution measured over the film is 20 or less, glare developed when the film of the invention is applied to a high precision panel can be eliminated to advantage.

When the optical properties of the anti-reflection layer employable herein are such that the specular reflectance is 2.5% or less, the transmission is 90% or more and the 60° gloss is 70% or less, the reflection of external light can be inhibited, making it possible to enhance the viewability to advantage. In particular, the specular reflectance is more preferably 1% or less, most preferably 0.5% or less. When the haze is from 20% to 50%, the ratio of inner haze to total haze is from 0.3 to 1, the reduction of haze from that up to the light-scattering layer to that developed after the formation of the lower refractive layer is 15% or less, the sharpness of transmitted image at an optical comb width of 0.5 mm is from 20% to 50% and the ratio of transmission of vertical transmitted light to transmission of transmitted light in the direction of 2 degrees from the vertical direction is from 1.5 to 5.0, the prevention of glare on a high precision LCD panel and the elimination of blurring of letters, etc. can be attained to advantage.

(Lower Refractive Layer)

The refractive index of the lower refractive layer employable herein is preferably from 1.20 to 1.49, more preferably from 1.30 to 1.44. Further, the lower refractive layer preferably satisfies formula (6) to advantage from the standpoint of reduction of reflectance.
(m/4)×0.7<n₁d₁<(m/4)×1.3 (6)
wherein m represents a positive odd number; n₁ represents the refractive index of the lower refractive layer; and d, represents the thickness (nm) of the lower refractive layer.

The materials constituting the lower refractive layer will be described hereinafter.

The lower refractive layer preferably comprises a fluorine-containing polymer incorporated therein as a low refractive binder. As such a fluorine-based polymer there is preferably used a thermally or ionized radiation-crosslinkable fluorine-containing polymer having a dynamic friction coefficient of from 0.03 to 0.20, a contact angle of from 90 to 120° with respect to water and a purified water slip angle of 70° or less. As the peel force of the polarizing plate of the invention with respect to a commercially available adhesive tape during the mounting on the image display device decreases, the polarizing plate can be more easily peeled after the sticking of seal or memo to advantage. The peel force of the polarizing plate is preferably 500 gf or less, more preferably 300 gf or less, most preferably 100 gf or less as measured by a tensile testing machine. The higher the surface hardness as measured by a microhardness meter is, the more difficultly can be damaged the lower refractive layer. The surface hardness of the lower refractive layer is preferably 0.3 GPa or more, more preferably 0.5 GPa or more.

Examples of the fluorine-containing polymer to be used in the lower refractive layer include hydrolyzates and dehydration condensates of perfluoroalkyl group-containing silane compounds (e.g., (heptadecafluoro-1,1,2,2-tetrahydrodecyl)triethoxysilane). Other examples of the fluorine-containing polymer include fluorine-containing copolymers comprising a fluorine-containing monomer unit and a constituent unit for providing crosslinking reactivity as constituent components.

Specific examples of the fluorine-containing monomers include fluoroolefins (e.g., fluoroethylene, vinylidene fluoride, tetrafluoroethylene, perfluorooctylethylene, hexafluoropropylene, perfluoro-2,2-dimethyl-1,3-dioxol), partly or fully fluorinated alkylester derivatives of (meth)acrylic acid (e.g., Biscoat 6FM (produced by OSAKA ORGANIC CHEMICAL INDUSTRY LTD.), M-2020 (produced by DAIKIN INDUSTRIES, Ltd.), and fully or partly fluorinated vinyl ethers. Preferred among these fluorine-containing monomers are perfluoroolefins. Particularly preferred among these fluorine-containing monomers is hexafluoropropylene from the standpoint of refractive index, solubility, transparency, availability, etc.

Examples of the constituent unit for providing crosslinking reactivity include constituent units obtained by the polymerization of monomers previously having a self-crosslinking functional group such as glycidyl(meth)acrylate and glycidyl vinyl ether, constituent units obtained by the polymerization of monomers having carboxyl group, hydroxyl group, amino group, sulfo group or the like (e.g., (meth)acrylic acid, methyl(meth)acrylate, hydroxylalkyl(meth)acrylate, allyl acrylate, hydroxyethyl vinyl ether, hydroxybutyl vinyl ether, maleic acid, crotonic acid), and constituent units obtained by introducing a crosslinking reactive group such as (meth)acryloyl group into these constituent units by a polymer reaction (e.g., by reacting acrylic acid chloride with hydroxyl group).

Besides the aforementioned fluorine-containing monomer units and constituent units for providing crosslinking reactivity, monomers free of fluorine atom may be properly copolymerized from the standpoint of solubility in the solvent, transparency of the film, etc. The monomer units which can be used in combination with the aforementioned monomer units are not specifically limited. Examples of these monomer units include olefins (e.g., ethylene, propylene, isoprene, vinyl chloride, vinylidene chloride), acrylic acid esters (e.g., methyl acrylate, ethyl acrylate, 2-ethylhexyl acrylate), methacrylic acid esters (e.g., methyl methacrylate, ethyl methacrylate, butyl methacrylate, ethylene glycol dimethacrylate), styrene derivatives (e.g., styrene, divinyl ether, vinyl toluene, a-methyl styrene), vinylethers (e.g., methyl vinyl ether, ethyl vinyl ether, cyclohexyl vinyl ether), vinylesters (e.g., vinyl acetate, vinyl propionate, vinyl cinnamate), acrylamides (e.g., N-tert-butyl acrylamide, N-cyclohexyl acrylamide), methacrylamides, and acrylonitrile derivatives.

The aforementioned polymers may be used properly in combination with a hardener as disclosed in JP-A-10-25388 and JP-A-10-147739.

(Light-Scattering Layer)

The light-scattering layer is formed for the purpose of providing the film with light-scattering properties developed by any of surface scattering and inner scattering and hard coating properties for the enhancement of scratch resistance of the film. Accordingly, the light-scattering layer comprises a binder for providing hard coating properties, a particulate mat for providing light diffusibility and optionally an inorganic filler for the enhancement of refractive index, the prevention of crosslink shrinkage and the enhancement of strength incorporated therein.

The thickness of the light-scattering layer is from 1 to 10 μm, more preferably from 1.2 to 6 μm for the purpose of providing hard coating properties. When the thickness of the light-scattering layer falls with this range, the resulting light-scattering layer has a sufficient hardness. The resulting polarizing plate has no problems with curling resistance and brittleness and hence a good adaptability to working.

The binder to be incorporated in the light-scattering layer is preferably a polymer having a saturated hydrocarbon chain or polyether chain as a main chain, more preferably a polymer having a saturated hydrocarbon chain as a main chain. The binder polymer preferably has a crosslinked structure. As the binder polymer having a saturated hydrocarbon chain as a main chain there is preferably used a polymer of ethylenically unsaturated monomers. As the binder polymer having a saturated hydrocarbon chain as a main chain and a crosslinked structure there is preferably used a (co)polymer of monomers having two or more ethylenically unsaturated groups. In order to provide the binder polymer with a higher refractive index, those containing an aromatic ring or at least one atom selected from the group consisting of halogen atoms other than fluorine, sulfur atom, phosphorus atom and nitrogen atom may be selected.

Examples of the monomer having two or more ethylenically unsaturated groups include esters of polyvalent alcohol with (meth)acrylic acid (e.g., ethylene glycol di(meth)acrylate, butanediol di(meth)acrylate, hexanediol di(meth)acrylate, 1,4-cyclohexanediacrylate, pentaerythritol tetra(meth)acrylate, pentaerythritol tri(meth)acrylate, trimethylolpropane tri(meth)acrylate, trimethylol ethane tri(meth)acrylate, dipentaerythritol penta(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, polyester polyacrylate), modification products of the aforementioned ethylene oxides, vinylbenzene and derivatives thereof (e.g., 1,4-divinylbenzene, 4-vinyl benzoic acid-2-acryloylethylester, 1,4-divinyl cyclohexanone), vinylsulfones (e.g., divinylsulfone), acrylamides (e.g., methylenebisacrylamide), and methacrylamides. The aforementioned monomers may be used in combination of two or more thereof.

Specific examples of the higher refractive monomer include bis(4-methacryloylthiophenyl)sulfide, vinyl naphthalene, vinyl phenyl sulfide, and 4-methacryloxy phenyl-4′-methoxyphenylthioether. These monomers, too, may be used in combination of two or more thereof.

The polymerization of the monomers having these ethylenically unsaturated groups can be effected by irradiation with ionized radiation or heating in the presence of a photo-radical polymerization initiator or heat-radical polymerization initiator. Accordingly, a lower refractive layer can be formed by a process which comprises preparing a coating solution containing a monomer having an ethylenically unsaturated group, a photo-polymerization initiator or heat radical polymerization initiator, a particulate mat and an inorganic filler, spreading the coating solution over a transparent support, and then irradiating the coat with ionized radiation or applying heat to the coat to cause polymerization reaction and curing. As such a photo-polymerization initiator or the like there may be used any compound known as such.

As the polymer having a polyether as a main chain there is preferably used an open-ring polymerization product of polyfunctional epoxy compound. The open-ring polymerization of the polyfunctional epoxy compound can be carried out by the irradiation of the polyfunctional epoxy compound with ionized radiation or applying heat to the polyfunctional epoxy compound in the presence of a photo-acid generator or heat-acid generator. Accordingly, a lower refractive layer can be formed by a process which comprises preparing a coating solution containing a polyfunctional epoxy compound, a photo-acid generator or heat-acid generator, a particulate mat and an inorganic filler, spreading the coating solution over the transparent support, and then irradiating the coat layer with ionized radiation or applying heat to the coat layer to cause polymerization reaction and curing. As such an acid-generator or the like there may be used a material known as such.

Instead of or in addition to the monomer having two or more ethylenically unsaturated groups, a monomer having a crosslinkable functional group may be used to incorporate a crosslinkable functional group in the polymer so that the crosslinkable functional group is reacted to incorporate a crosslinked structure in the binder polymer.

Examples of the crosslinkable functional group include isocyanate group, epoxy group, aziridin group, oxazoline group, aldehyde group, carbonyl group, hydrazine group, carboxyl group, methylol group, and active methylene group. Vinylsulfonic acids, acid anhydries, cyanoacrylate derivatives, melamines, etherified methylol, esters, urethane, and metal alkoxides such as tetramethoxysilane, too, may be used as monomers for introducing crosslinked structure. Functional groups which exhibit crosslinkability as a result of decomposition reaction such as block isocyanate group may be used. In other words, in the invention, the crosslinkable functional group may not be reactive as they are but may become reactive as a result of decomposition reaction. These binder polymers having a crosslinkable functional group may be spread and heated to form a crosslinked structure.

The light-scattering layer comprises a particulate mat incorporated therein having an average particle diameter which is greater than that of filler particles and ranges from 1 to 10 μm, preferably from 1.5 to 7.0 μm, such as inorganic particulate compound and particulate resin for the purpose of providing itself with anti-glare properties.

Specific examples of the aforementioned particulate mat include inorganic particulate compounds such as particulate silica and particulate TiO₂, and particulate resins such as particulate acryl, particulate crosslinked acryl, particulate polystyrene, particulate crosslinked styrene, particulate melamine resin and particulate benzoguanamine resin. Preferred among these particulate resins are particulate crosslinked styrene, particulate crosslinked acryl, particulate crosslinked acryl styrene, and particulate silica.

The particulate mat may be either spherical or amorphous.

Two or more particulate mats having different particle diameters may be used in combination. A particulate mat having a greater particle diameter may be used to provide the light-scattering layer with anti-glare properties. A particulate mat having a greater particle diameter may be used to provide the light-scattering layer with other optical properties.

Further, the distribution of the particle diameter of the mat particles is most preferably monodisperse. The particle diameter of the various particles are preferably as close to each other as possible. For example, in the case where a particle having a diameter of 20% or more greater than the average particle diameter is defined as coarse particle, the proportion of these coarse particles is preferably 1% or less, more preferably 0.1% or less, even more preferably 0.01% or less of the total number of particles. A particulate mat having a particle diameter distribution falling within the above defined range can be obtained by properly classifying the mat particles obtained by an ordinary synthesis method. By raising the number of classifying steps or intensifying the degree of classification, a matting agent having a better distribution can be obtained.

The aforementioned particulate mat is incorporated in the light-scattering layer in such a manner that the proportion of the particulate mat in the light-scattering layer is from 10 to 1,000 mg/m², more preferably from 100 to 700 mg/m².

For the measurement of the distribution of particle size of mat particles, a coulter counter method. The particle size distribution thus measured is then converted to distribution of number of particles.

The light-scattering layer preferably comprises an inorganic filler made of an oxide of at least one metal selected from the group consisting of titanium, zirconium, aluminum, indium, zinc, tin and antimony having an average particle diameter of 0.2 μm or less, preferably 0.1 μm or less, more preferably 0.06 μm or less incorporated therein in addition to the aforementioned particulate mat to enhance the refractive index thereof.

In order to enhance the difference of refractive index from the particulate mat, the light-scattering layer comprising a high refractive particulate mat incorporated therein preferably comprises a silicon oxide incorporated therein for keeping the refractive index thereof somewhat low. The preferred particle diameter of the particulate silicon oxide is the same as that of the aforementioned inorganic filler.

Specific examples of the inorganic filler to be incorporated in the light-scattering layer include TiO₂, ZrO₂, Al₂O₃, In₂O₃, ZnO, SnO₂, Sb₂O₃, ITO, and SiO₂. Particularly preferred among these inorganic fillers are TiO₂ and ZrO₂ from the standpoint of enhancement of refractive index. The inorganic filler is preferably subjected to silane coupling treatment or titanium coupling treatment on the surface thereof. To this end, a surface treatment having a functional group reactive with the binder seed on the surface thereof is preferably used.

The amount of the inorganic filler to be incorporated is preferably from 10 to 90%, more preferably from 20 to 80%, particularly from 30 to 75% based on the total weight of the light-scattering layer.

Such a filler has a particle diameter which is sufficiently smaller than the wavelength of light and thus causes no scattering. Thus, a dispersion having such a filler dispersed in a binder polymer behaves as an optically uniform material.

The bulk refractive index of the mixture of binder and inorganic filler in the light-scattering layer is preferably from 1.48 to 2.00, more preferably from 1.50 to 1.80. In order to predetermine the bulk refractive index of the mixture within the above defined range, the kind and proportion of the binder and the inorganic filler may be properly selected. How to select these factors can be previously easily known experimentally.

In order to keep the light-scattering layer uniform in surface conditions such as uniformity in coating and drying and prevention of point defects, the coating solution for forming the light-scattering layer comprises either or both of fluorine-based surface active agent and silicone-based surface active agent incorporated therein. In particular, a fluorine-based surface active agent is preferably used because it can be used in a smaller amount to exert an effect of eliminating surface defects such as unevenness in coating and drying and point defects of the anti-reflection film of the invention. Such a fluorine-based surface active agent is intended to render the coating solution adaptable to high speed coating while enhancing the uniformity in surface conditions, thereby raising the productivity.

The anti-reflection layer (ii) including a middle refractive layer, a higher refractive layer and a lower refractive layer stacked on a protective film in this order will be described hereinafter.

The anti-reflection layer including a layer structure having at least a middle refractive layer, a higher refractive layer and a lower refractive layer (outermost layer) stacked on a protective film in this order is designed so as to have a refractive index satisfying the following relationship.

Refractive index of higher refractive layer>refractive index of middle refractive layer>refractive index of protective film>refractive index of lower refractive layer

Further, a hard coat layer may be provided interposed between the protective film and the middle refractive layer. Moreover, the anti-reflection layer may include a middle refractive layer, a hard coat layer, a higher refractive layer and a lower refractive layer laminated on each other. For example, an anti-reflection layer as disclosed in JP-A-8-122504, JP-A-8-110401, JP-A-10-300902, JP-A-2002-243906, and JP-A-2000-111706 may be used. Further, the various layers may be provided with other functions. Examples of these layers include stain-proof lower refractive layer, and antistatic higher refractive layer (as disclosed in JP-A-10-206603, JP-A-2002-243906).

The haze of the anti-reflection layer is preferably 5% or less, more preferably 3% or less. The strength of the anti-reflection layer is preferably not lower than H, more preferably not lower than 2H, most preferably not lower than 3H as determined by pencil hardness test method according to JIS K5400.

(Higher Refractive Layer and Middle Refractive Layer)

The layer having a high refractive index in the anti-reflection layer is formed by a hardened layer containing at least a higher refractive inorganic particulate compound having an average particle diameter of 100 nm or less and a matrix binder.

As the higher refractive inorganic particulate compound there may be used an inorganic compound having a refractive index of 1.65 or more, preferably 1.9 or more. Examples of such a higher refractive inorganic particulate compound include oxides of Ti, Zn, Sb, Sn, Zr, Ce, Ta, La and In, and composite oxides of these metal atoms.

In order to provide such a particulate material, the following requirements need to be satisfied. For example, the surface of the particles must be treated with a surface treatment (e.g., silane coupling agent as disclosed in JP-A-11-295503, JP-A-11-153703, and JP-A-2000-9908, anionic compound or organic metal coupling agent as disclosed in JP-A-2001-310432). Further, the particles must have a core-shell structure comprising a high refractive particle as a core (as disclosed in JP-A-2001-166104). A specific dispersant must be used at the same time (as disclosed in JP-A-11-153703, U.S. Pat. No. 6,210,858B1, JP-A-2002-2776069).

Examples of the matrix-forming materials include known thermoplastic resins, thermosetting resins, etc.

Preferred examples of the matrix-forming materials include polyfunctional compound-containing compositions having two or more of at least any of radically polymerizable group and/or cationically polymerizable group, compositions having an organic metal compound containing a hydrolyzable group, and at least one selected from the group consisting of compositions containing a partial condensate thereof. Examples of these materials include compounds as disclosed in JP-A-2000-47004, JP-A-2001-315242, JP-A-2001-31871, and JP-A-2001-296401.

Further, a colloidal metal oxide obtained from a hydrolytic condensate of metal alkoxide and a curable layer obtained from a metal alkoxide composition are preferably used. For the details of these materials, reference can be made to JP-A-2001-293818.

The refractive index of the higher refractive layer is preferably from 1.70 to 2.20. The thickness of the higher refractive layer is preferably from 5 nm to 10 μm, more preferably from 10 nm to 1 μm.

The refractive index of the middle refractive layer is adjusted so as to fall between the refractive index of the lower refractive layer and the higher refractive layer. The refractive index of the middle refractive layer is preferably from 1.50 to 1.70. The thickness of the middle refractive layer is preferably from 5 nm to 10 μm, more preferably from 10 nm to 1 μm.

(Lower Refractive Layer)

The lower refractive layer is stacked on the higher refractive layer. The refractive index of the lower refractive layer is preferably from 1.20 to 1.55, more preferably from 1.30 to 1.50. The lower refractive layer is preferably designed as an outermost layer having scratch resistance and stain resistance. In order to drastically raise the scratch resistance of the lower refractive layer, a thin layer which can effectively provide surface slipperiness may be formed on the lower refractive layer by introducing a known silicone or fluorine thereinto.

The refractive index of the fluorine-containing compound is preferably from 1.35 to 1.50, more preferably from 1.36 to 1.47. As the fluorine-containing compound there is preferably used a compound containing a crosslinkable or polymerizable functional group having fluorine atoms in an amount of from 35 to 80% by weight. Examples of such a compound include those disclosed in JP-A-9-222503, paragraphs (0018)-(0026), JP-A-11-38202, paragraphs (0019)-(0030), JP-A-2001-40284, paragraphs (0027)-(0028), and JP-A-284102.

As the silicone compound there is preferably used a compound having a polysiloxane structure wherein a curable functional group or polymerizable functional group is incorporated in the polymer chain to form a bridged structure in the film. Examples of such a compound include reactive silicones (e.g., SILAPLANE, produced by CHISSO CORPORATION), and polysiloxanes having silanol group at both ends thereof (as disclosed in JP-A-11-258403).

In order to effect the crosslinking or polymerization reaction of at least any of fluorine-containing polymer and siloxane polymer having crosslikable or polymerizable group, the coating composition for forming the outermost layer containing a polymerization initiator, a sensitizer, etc. is preferably irradiated with light or heated at the same time with or after spreading to form a lower refractive layer. As the polymerization initiator, sensitizer, etc. there may be used any materials known as such.

Further, a sol-gel cured film obtained by curing an organic metal compound such as silane coupling agent and a silane coupling agent containing a specific fluorine-containing hydrocarbon group in the presence of a catalyst is preferably used. Examples of such a sol-gel cured film include polyfluoroalkyl group-containing silane compounds and partial hydrolytic condensates thereof (compounds as disclosed in JP-A-58-142958, JP-A-58-14783, JP-A-58-147484, JP-A-9-157582, and JP-A-11-106704), and silyl compounds having poly(perfluoroalkylether) group as a fluorine-containing long chain (compounds as disclosed in JP-A-2000-117902, JP-A-2001-48590, JP-A-2002-53804).

The lower refractive layer may include a filler (e.g., low refractive inorganic compound having a primary average particle diameter of from 1 to 150 nm such as particulate silicon dioxide (silica) and particulate fluorine-containing material (magnesium fluoride, calcium fluoride, barium fluoride), organic particulate material as disclosed in JP-A-11-3820, paragraphs (0020)-(0038)), a silane coupling agent, a lubricant, a surface active agent, etc. incorporated therein as additives other than the aforementioned additives. In the case where the lower refractive layer is disposed under the outermost layer, the lower refractive layer may be formed by a gas phase method (vacuum metallizing method, sputtering method, ion plating method, plasma CVD method, etc.). A coating method is desirable because the lower refractive layer can be produced at reduced cost. The thickness of the lower refractive layer is preferably from 30 to 200 nm, more preferably from 50 to 150 nm, most preferably from 60 to 120 nm.

(Layers Other than Anti-Reflection Layer)

Further, a hard coat layer, a forward scattering layer, a primer layer, an antistatic layer, an undercoating layer, a protective film, etc. may be provided.

(Hard Coat Layer)

The hard coat layer is provided on the surface of the protective film to give a physical strength to the protective film having an anti-reflection layer provided thereon. In particular, the hard coat layer is preferably provided interposed between the transparent support and the aforementioned higher refractive layer.

The hard coat layer is preferably formed by the crosslinking reaction or polymerization reaction of a photosetting and/or thermosetting compound. The curable functional group in the curable compound is preferably a photopolymerizable functional group. Further, an organic metal compound or organic alkoxysilyl compound containing a hydrolyzable functional group is desirable. Specific examples of these compounds include the same compounds as exemplified with reference to the higher refractive layer. Specific examples of the composition constituting the hard coat layer include those described in JP-A-2002-144913, JP-A-2000-9908, and WO00/46617.

The higher refractive layer may act also as a hard coat layer. In this case, particles may be finely dispersed in a hard coat layer in the same manner as described with reference to the higher refractive layer to form a higher refractive layer.

The hard coat layer may comprise particles having an average particle diameter of from 0.2 to 10 μm incorporated therein to act also as an anti-glare layer provided with anti-glare properties. The provision of the anti-glare properties can be carried out by any known method.

(0206)

The thickness of the hard coat layer may be properly designed depending on the purpose. The thickness of the hard coat layer is preferably from 0.2 to 10 μm, more preferably from 0.5 to 7 μm.

The strength of the hard coat layer is preferably not lower than H, more preferably not lower than 2H, most preferably not lower than 3H as determined by pencil hardness test according to JIS K5400. The abrasion of the test specimen is preferably as little as possible when subjected to taper test according to JIS K5400.

(Antistatic Layer)

The antistatic layer, if provided, is preferably given an electrical conductivity of 10⁻⁸ (Ωcm⁻³) or less as calculated in terms of volume resistivity. The use of a hygroscopic material, a water-soluble inorganic salt, a certain kind of a surface active agent, a cation polymer, an anion polymer, colloidal silica, etc. makes it possible to provide a volume resistivity of 10⁻⁸ (Ωcm⁻³). However, these materials have a great dependence on temperature and humidity and thus cannot provide a sufficient electrical conductivity at low humidity. Therefore, as the electrically conductive layer material there is preferably used a metal oxide. Some metal oxides have a color. The use of such a colored metal oxide as an electrically conductive layer material causes the entire film to be colored to disadvantage.

Examples of metal that forms a colorless metal oxide include Zn, Ti, Al, In, Si, Mg, Ba, Mo, W, and V. Metal oxides mainly composed of these metals are preferably used. Specific examples of these metal oxides include ZnO, TiO₂, SnO₂, Al₂O₃, In₂O₃, SiO₂, MgO, BaO, MoO₃, V₂O₅, and composites thereof. Particularly preferred among these metal oxides are ZnO, TiO₂, and SnO₂. Referring to the incorporation of different kinds of atoms, Al, In, etc. are effectively added to ZnO. Sb, Nb, halogen atoms, etc. are effectively added to SnO₂. Nb, Ta, etc. are effectively added to TiO₂. Further, as disclosed in JP-B-59-6235, materials comprising the aforementioned metal oxide attached to other crystalline metal particles or fibrous materials (e.g., titanium oxide) may be used.

Volume resistivity and surface resistivity are different physical values and thus cannot be simply compared with each other. However, in order to provide an electrical conductivity of 10⁻⁸ (Ωcm⁻³) or less as calculated in terms of volume resistivity, it suffices if the electrically conductive layer has an electrical conductivity of approximately 10⁻¹⁰ (Ω/□) or less, preferably 10⁻⁸ (Ω/□) or less as calculated in terms of surface resistivity. It is necessary that the surface resistivity of the electrically conductive layer be measured when the antistatic layer is provided as an outermost layer. In the invention, the measurement of surface resistivity can be effected at a step in the course of the formation of laminated film.

(Liquid Crystal Display Device)

The polarizing plate including an optical compensation sheet of the aforementioned cellulose acylate film and an anti-reflection layer can be used in liquid crystal display devices, particularly transmission type liquid crystal display devices to advantage.

A transmission type liquid crystal display device includes a liquid crystal cell and two polarizing plates disposed on the respective side of the liquid crystal cell. The liquid crystal cell includes a liquid crystal supported interposed between two electrode substrates.

In an exemplary embodiment of the transmission type liquid crystal display device of the invention, the optical compensation sheet of the invention is disposed interposed between the liquid crystal cell and one or both of the polarizing plates.

In another embodiment of implementation of the transmission type liquid crystal display device of the invention, as the transparent protective film to be disposed between the liquid crystal cell and the polarizing film there is used an optical compensation sheet of the aforementioned cellulose acylate film. The optical compensation sheet of the cellulose acylate film and the polarizing film are preferably aligned such that the slow axis of the optical compensation sheet and the transmission axis of the polarizing film are oriented substantially parallel to each other. The aforementioned optical compensation sheet may be used only as the transparent protective film for one of the polarizing plates (disposed between the liquid crystal cell and the polarizing film). Alternatively, the aforementioned optical compensation sheet may be used as the transparent protective film for both the two polarizing plates (disposed between the liquid crystal cell and the polarizing film).

The liquid crystal cell is preferably of VA mode.

In a VA mode liquid crystal cell, rod-shaped liquid crystal molecules are vertically oriented when no voltage is applied.

VA mode liquid crystal cells include (1) liquid crystal cell in VA mode in a narrow sense in which rod-shaped liquid crystal molecules are oriented substantially vertically when no voltage is applied but substantially horizontally when a voltage is applied (as disclosed in JP-A-2-176625). In addition to the VA mode liquid crystal cell (1), there have been provided (2) liquid crystal cell of VA mode which is multidomained to expand the viewing angle (MVA mode) (as disclosed in SID97, Digest of Tech. Papers (preprint) 28 (1997), 845), (3) liquid crystal cell of mode in which rod-shaped molecules are oriented substantially vertically when no voltage is applied but oriented in twisted multidomained mode when a voltage is applied (n-ASM mode, CAP mode) (as disclosed in Preprints of Symposium on Japanese Liquid Crystal Society Nos. 58 to 59, 1988 and (4) liquid crystal cell of SURVALVAL mode (as reported in LCD International 98).

### EXAMPLE

The invention will be further described in the following examples, but the invention is not limited thereto.

### Example 1

### 1. Preparation of Cellulose Acylate Film

(1) Preparation of Cellulose Acylate

Cellulose acylates having different kinds of acyl groups and substitution degrees as set forth in Table 1 were prepared. In some detail, sulfuric acid was added as a catalyst (in an amount of 7.8 parts by weight based on 100 parts by weight of cellulose). In the presence of this catalyst, a carboxylic acid as a raw material of acyl substituent was then subjected to acylation reaction at 40° C. During this procedure, the kind and amount of carboxylic acid used was adjusted to adjust the kind and substitution degree of acyl group. The carboxylic acid thus acylated was then ripened at 40° C. The low molecular components of cellulose acylate were then removed by washing with acetone. In Table 1, CAB stands for cellulose acylate butyrate (cellulose acetate derivative containing acetate and butyryl groups as acyl groups), CAP stands for cellulose acetate propionate (cellulose ester derivative containing acetate and propionyl groups as acyl groups), and CTA stands for cellulose triacetate (cellulose ester derivative containing acetate groups alone as acyl groups).

(2) Dissolution

Cellulose acylates, plasticizers and retardation adjustors were added to a 87:13 (by weight) mixture of dichloromethane and methanol with stirring in such an amount that the weight concentration of cotton reached 15% by weight. The mixture was then heated with stirring to make solution. As an ultraviolet absorber, if used, there was added an ultraviolet absorber B (“TINUVIN 327”, produced by Ciba Specialty Chemicals Co., Ltd.) or an ultraviolet absorber C (“TINUVIN 328”, produced by Ciba Specialty Chemicals Co., Ltd.) in an amount of 0.375 parts by weight or 0.75 parts by weight based on 100 parts by weight of cellulose acylate, respectively.

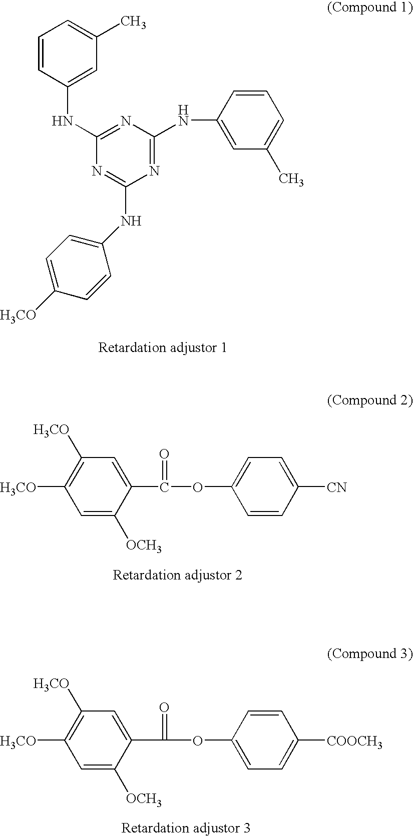

The dope thus obtained was then casted using a band casting machine. The dope thus casted was crosswise stretched at a temperature and a draw ratio set forth in Table 1 while retaining residual solvent in an amount set forth in Table 1 using a tenter, shrunk by a factor of 20%, and then dried at 125° C. to prepare cellulose acylate films having a thickness set forth in Table 1. The cellulose acylate films (optical compensation sheet) thus prepared were each then measured for Re retardation value and Rth retardation value at 633 nm using a Type M-150 ellipsometer (produced by JASCO CO., LTD.). The cellulose acylate films of the invention showed an amount of Re/Rth change of from 0.011 to 0.016 per % of draw ratio. The comparative cellulose acylate films showed a Re/Rth change of 0.001.

These films each showed a 25° C. elastic modulus of 150 kgf/mm² to 300 kgf/mm² and a haze of from 0.1 to 0.9. The secondary average particle diameter of the matting agent (“Sumisorb 165F”, produced by Sumitomo Chemical Co., Ltd.) incorporated in these films was 1.0 μm. These films showed a weight change of from 0 to 3% after 48 hours of standing at 80° C. and 90% RH. These films also showed a dimensional change of from 0 to 4.5% after 24 hours of standing at 90° C. and 5% RH. All these samples showed an optoelastic coefficient of 50×10⁻¹³ cm²/dyne or less.

TABLE 1

| | | | Cellulose acylate | | | | |
|---|---|---|---|---|---|---|---|
| | | | | | | Total | |
| | | | Ac group | | | degree of | |
| | Execution | | Degree | Bu/Pr group | | substitution | DS6/ |
| | No. | Kind of cotton | of substitution | Kind | Substitution | (DS2 + DS3 + DS6) | (DS2 + DS3 + DS6) |
| Inventive | F1 | CAB | 0.9 | Bu | 1.8 | 2.7 | 0.3 |
| Inventive | F2 | CAB | 0.9 | Bu | 1.8 | 2.7 | 0.3 |
| Inventive | F3 | CAP | 1.9 | Pr | 0.8 | 2.7 | 0.31 |
| Inventive | F4 | CAP | 1.9 | Pr | 0.8 | 2.7 | 0.31 |
| Inventive | F5 | CTA | 2.87 | — | — | 2.87 | 0.3 |
| Inventive | F6 | CTA | 2.87 | — | — | 2.87 | 0.3 |
| Inventive | F7 | CTA | 2.87 | — | — | 2.87 | 0.3 |
| Inventive | F8 | CTA | 2.80 | — | — | 2.80 | 0.32 |
| Inventive | F9 | CTA | 2.80 | — | — | 2.80 | 0.32 |
| Comparative | F10 | CAB | 0.9 | Bu | 1.8 | 2.7 | 0.3 |
| Comparative | F11 | CAP | 1.9 | Pr | 0.8 | 2.7 | 0.31 |
| Comparative | F12 | CTA | 2.87 | — | 0 | 2.87 | 0.3 |

| | | | | | Content | | | | Retardation | |
|---|---|---|---|---|---|---|---|---|---|---|
| | | | Retardation | | (%) of | Stretching | Draw | Dry | value | |
| | Execution | Plasticizer | adjustor | | residual | temperature | ratio | thickness | Re | |
| | No. | TPP/BDP | Kind | Amount | solvent | (° C.) | (%) | (μm) | (nm) | Rth (nm) |
| Inventive | F1 | 5.8 | Compound 1 | 6 | 30 | 130 | 15 | 80 | 32 | 140 |
| Inventive | F2 | 11.7 | Compound 2 | 4.5 | 30 | 130 | 25 | 92 | 40 | 130 |
| | | | Compound 3 | 4.5 | | | | | | |
| Inventive | F3 | 11.7 | Compound 1 | 6 | 30 | 130 | 18 | 80 | 45 | 148 |
| Inventive | F4 | 11.7 | Compound 2 | 4.5 | 30 | 130 | 25 | 92 | 50 | 130 |
| | | | Compound 3 | 4.5 | | | | | | |
| Inventive | F5 | 11.7 | Compound | 3 | 25 | 140 | 32 | 92 | 32 | 135 |
| Inventive | F6 | 11.7 | Compound 2 | 3.5 | 25 | 140 | 25 | 92 | 40 | 140 |
| | | | Compound 3 | 3.5 | | | | | | |
| Inventive | F7 | 11.7 | Compound 1 | 3 | 25 | 140 | 32 | 108 | 50 | 250 |
| Inventive | F8 | 11.7 | Compound 1 | 5.1 | 25 | 145 | 32 | 93 | 65 | 230 |
| Inventive | F9 | 11.7 | Compound 1 | 3.4 | 25 | 145 | 32 | 93 | 70 | 220 |
| | | | Compound 3 | 2.6 | | | | | | |
| Comparative | F10 | 5.8 | None | — | 30 | 130 | 0 | 80 | 2 | 29 |
| Comparative | F11 | 11.7 | None | — | 30 | 130 | 0 | 80 | 3 | 32 |
| Comparative | F12 | 11.7 | None | — | 25 | 140 | 0 | 92 | 5 | 52 |

### 2. Preparation of Polarizing Plate

### Comparative Example 1 of Polarizing Plate

A PVA film having an average polymerization degree of 2,400 and a thickness of 75 μm was previously swollen with a 15° C. deionized water for 48 seconds. Using a blade made of stainless steel, the surface of the PVA film was then wiped to remove water content. The PVA film was then dipped in an aqueous solution having an iodine content of 0.9 g/l and a potassium iodide content of 60.0 g/l (dyeing solution) at 40° C. with the aqueous solution being corrected to have a constant concentration for 55 seconds, dipped in an aqueous solution having a boric acid content of 42.5 g/l and a potassium iodide content of 30 g/l (hardening solution) at 40° C. with the aqueous solution being corrected to have a constant concentration for 90 seconds, and then stretched in the aqueous solution by a factor of 6.4. The polarizing film thus formed had a thickness of 29 μm. The polarizing film was trimmed at crosswise ends thereof by 3 cm using a cutter, stuck to Fujitac (cellulose triacetate; in-plane retardation value: 3.0 nm; thickness: 80 μm, produced by Fuji Photo Film Co., Ltd.) which had been saponified with a 3% aqueous solution of PVA (PVA-124H, produced by Kuraray Co., Ltd.) as an adhesive, and then heated to 60° C. for 15 minutes to prepare a rolled polarizing plate having an effective width of 650 nm and a length of 100 nm. The polarizing plate thus prepared is set forth in Table 2.

### Comparative Example 2 of Polarizing Plate

A PVA film having an average polymerization degree of 2,400 and a thickness of 75 μm was previously swollen with a 15° C. deionized water for 48 seconds. Using a blade made of stainless steel, the surface of the PVA film was then wiped to remove water content. The PVA film was then dipped in an aqueous solution having an iodine content of 0.9 g/l and a potassium iodide content of 60.0 g/l (dyeing solution) at 40° C. with the aqueous solution being corrected to have a constant concentration for 40 seconds, dipped in an aqueous solution having a boric acid content of 42.5 g/l and a potassium iodide content of 30 g/l (hardening solution) at 40° C. with the aqueous solution being corrected to have a constant concentration for 90 seconds, and then stretched in the aqueous solution by a factor of 6.3. The polarizing film thus formed had a thickness of 29 μm. The polarizing film was trimmed at crosswise ends thereof by 3 cm using a cutter, stuck to Fujitac (cellulose triacetate; in-plane retardation value: 3.0 nm; thickness: 80 μm, produced by Fuji Photo Film Co., Ltd.) which had been saponified with a 3% aqueous solution of PVA (PVA-124H, produced by Kuraray Co., Ltd.) as an adhesive, and then heated to 60° C. for 15 minutes to prepare a rolled polarizing plate having an effective width of 650 nm and a length of 100 nm. The polarizing plate thus prepared is set forth in Table 2.

### Example 1 of Polarizing Plate

A PVA film having a number-average polymerization degree of 2,400 and a thickness of 50 μm was previously swollen with a 15° C. deionized water for 60 seconds. Using a blade made of stainless steel, the surface of the PVA film was then wiped to remove water content. The PVA film was then dipped in an aqueous solution having an iodine content of 1.0 g/l and a potassium iodide content of 60.0 g/l (dyeing solution) at 40° C. with the aqueous solution being corrected to have a constant concentration for 65 seconds, and then stretched by a factor of 6.3 in an aqueous solution having a boric acid content of 42.5 g/l and a potassium iodide content of 30 g/l (hardening solution) at 40° C. with the aqueous solution being corrected to have a constant concentration. The polarizing film thus formed had a thickness of 19 μm. The polarizing film was trimmed at crosswise ends thereof by 5 cm using a cutter, stuck to a saponified cellulose acylate film set forth in Table 1 on one side thereof and to Fujitac (cellulose triacetate; in-plane retardation value: 3.0 nm; thickness: 80 μm, produced by Fuji Photo Film Co., Ltd.) which had been saponified on the other with a 3% aqueous solution of PVA (PVA-124H, produced by Kuraray Co., Ltd.) as an adhesive, and then heated to 60° C. for 15 minutes to prepare a rolled polarizing plate having an effective width of 1,340 nm and a length of 500 nm. The polarizing plate thus prepared is set forth in Table 2.

### Example 2 of Polarizing Plate

A PVA film having a number-average polymerization degree of 2,400 and a thickness of 75 μm was previously swollen with a 15° C. deionized water for 60 seconds. Using a blade made of stainless steel, the surface of the PVA film was then wiped to remove water content. The PVA film was then dipped in an aqueous solution having an iodine content of 1.0 g/l and a potassium iodide content of 60.0 g/l (dyeing solution) at 40° C. with the aqueous solution being corrected to have a constant concentration for 60 seconds, and then stretched by a factor of 7.5 in an aqueous solution having a boric acid content of 50.0 g/l and a potassium iodide content of 15 g/l (hardening solution) at 40° C. with the aqueous solution being corrected to have a constant concentration. The polarizing film thus formed had a thickness of 21 μm. The polarizing film was trimmed at crosswise ends thereof by 5 cm using a cutter, stuck to a saponified cellulose acylate film set forth in Table 1 on one side thereof and to Fujitac (cellulose triacetate; in-plane retardation value: 3.0 nm; thickness: 80 μm, produced by Fuji Photo Film Co., Ltd.) which had been saponified on the other with a 3% aqueous solution of PVA (PVA-124H, produced by Kuraray Co., Ltd.) as an adhesive, and then heated to 60° C. for 15 minutes to prepare a rolled polarizing plate having an effective width of 1,340 nm and a length of 500 nm. The polarizing plate thus prepared is set forth in Table 2.

The saponification of the cellulose acylate film was conducted under the following conditions.

A 1.5 mol/l aqueous solution of sodium hydroxide was prepared and kept at 55° C. A 0.01 mol/l diluted aqueous solution of sulfuric acid was prepared and kept at 35° C. The cellulose acylate film thus prepared was dipped in the aforementioned aqueous solution of sodium hydroxide for 2 minutes, and then dipped in water so that the aqueous solution of sodium hydroxide was thoroughly washed away. Subsequently, the cellulose acylate film was dipped in the aforementioned diluted aqueous solution of sulfuric acid for 1 minute, and then dipped in water so that the diluted aqueous solution of sulfuric acid was thoroughly washed away. Finally, the sample was thoroughly dried at 120° C.

### 3. Evaluation of Performance of Polarizing Plate

(1) Polarization Degree

The polarizing plate thus obtained was measured for polarization degree using a Type UV3100 recording spectrophotometer (produced by Shimadzu Corporation).

The polarization degree was determined by the following equation supposing that the transmittance of two polarizing plates at the time the two polarizing plates are stacked on each other such that absorption axes of the two polarizing plates correspond with each other is H0 and the transmission of two polarizing plates at the time the two polarizing plates are stacked on each other such that absorption axes of the two polarizing plates are perpendicular to each other is H1.
Polarization degree P=((H0−H1)/(H0+H1))^{1/2}×100

It is necessary that the polarization degree P of the polarizing plate of the invention calculated by the aforementioned equation be 99.9% or more. The results are set forth in Table 2.

### 4. Mounting on VA Panel

A pair of polarizing plates and a pair of optical compensation sheets were peeled off a liquid crystal display device comprising a vertically aligned liquid crystal cell to obtain the liquid crystal cell.

### 5. Light Leakage

The vertically aligned liquid crystal cell mounted on the panel was allowed to stand under 60° C. dry conditions for 72 hours, allowed to stand at 25C and 60% RH for 72 hours, and then visually evaluated for light leakage with the panel light on. Light leakage, if any, was observed at the four corners of the panel.

Instead of the pair of polarizing plates and the pair of optical compensation sheets provided on the aforementioned liquid crystal display device comprising a vertically aligned liquid crystal cell, polarizing plates P1 to P12, P19 to P24, P26 to P31 and P33 to P44 set forth in Table 2 were each stuck to the liquid crystal cell one each on the viewer's side and the backlight side with an adhesive with the cellulose acylate film facing the liquid crystal cell. The polarizing plates P13 to P18, P25 and P32 were each stuck to the liquid crystal cell on the backlight side thereof with an adhesive with the cellulose acylate film facing the liquid crystal cell. A sheet of a commercially available polarizing plate (“HLC2-5618HCS”, produced by SANRITZ CORPORATION) was stuck to the viewer's side of the liquid crystal cell. The laminate was arranged in crossed nicols such that the transmission axis of the viewer's side polarizing plate is aligned vertically and the transmission axis of the backlight side polarizing plate is aligned horizontally.

The liquid crystal display device thus prepared was then observed. As a result, it was found that neutral black display had been realized in the forward direction as well as in the viewing direction. Using a Type EX-Contrast 160D measuring instrument (produced by ELDIM), the liquid crystal display device was then measured for viewing angle at 8 stages between black display (L1) and white display (L8) (within a range in which the contrast ratio is 10 or more and there is no brightness inversion on black side).

The provision of the polarizing plate of the invention made it possible to realize a wide viewing angle. The hue developed in black display was set forth in Table 2 with the results of visual observation.

TABLE 2

| | | | | | Polarizing | Panel display | | |
|---|---|---|---|---|---|---|---|---|
| | | Cellulose | | | properties | properties | | |
| | Execution | acylate | Polarizing | Thickness | Polarization | Viewing | | Light |
| | No. | prepared | plate | μm | degree | angle | | leakage |
| Inventive | P1 | F1 | Example 1 | 19 | 99.96% | >80° | >80° | Not |
| | | | | | | | | observed |
| Inventive | P2 | F1 | Example 2 | 21 | 99.97% | >80° | >80° | Not |
| | | | | | | | | observed |
| Inventive | P3 | F2 | Example 1 | 19 | 99.96% | >80° | >80° | Not |
| | | | | | | | | observed |
| Inventive | P4 | F2 | Example 2 | 21 | 99.97% | >80° | >80° | Not |
| | | | | | | | | observed |
| Inventive | P5 | F3 | Example 1 | 19 | 99.96% | >80° | >80° | Not |
| | | | | | | | | observed |
| Inventive | P6 | F3 | Example 2 | 21 | 99.97% | >80° | >80° | Not |
| | | | | | | | | observed |
| Inventive | P7 | F4 | Example 1 | 19 | 99.96% | >80° | >80° | Not |
| | | | | | | | | observed |
| Inventive | P8 | F4 | Example 2 | 21 | 99.97% | >80° | >80° | Not |
| | | | | | | | | observed |
| Inventive | P9 | F5 | Example 1 | 19 | 99.96% | >80° | >80° | Not |
| | | | | | | | | observed |
| Inventive | P10 | F5 | Example 2 | 21 | 99.97% | >80° | >80° | Not |
| | | | | | | | | observed |
| Inventive | P11 | F6 | Example 1 | 19 | 99.96% | >80° | >80° | Not |
| | | | | | | | | observed |
| Inventive | P12 | F6 | Example 2 | 21 | 99.97% | >80° | >80° | Not |
| | | | | | | | | observed |
| Inventive | P13 | F7 | Example 1 | 19 | 99.96% | >80° | >80° | Not |
| | | | | | | | | observed |
| Inventive | P14 | F7 | Example 2 | 21 | 99.97% | >80° | >80° | Not |
| | | | | | | | | observed |
| Inventive | P15 | F8 | Example 1 | 19 | 99.96% | >80° | >80° | Not |
| | | | | | | | | observed |
| Inventive | P16 | F8 | Example 2 | 21 | 99.97% | >80° | >80° | Not |
| | | | | | | | | observed |
| Inventive | P17 | F9 | Example 1 | 19 | 99.96% | >80° | >80° | Not |
| | | | | | | | | observed |
| Inventive | P18 | F9 | Example 2 | 21 | 99.97% | >80° | >80° | Not |
| | | | | | | | | observed |
| Comparative | P19 | F1 | Comparative | 29 | 99.96% | >80° | >80° | Some |
| | | | Example 1 | | | | | light |
| | | | | | | | | leakage |
| Comparative | P20 | F2 | Comparative | 29 | 99.96% | >80° | >80° | Some |
| | | | Example 1 | | | | | light |
| | | | | | | | | leakage |
| Comparative | P21 | F3 | Comparative | 29 | 99.96% | >80° | >80° | Some |
| | | | Example 1 | | | | | light |
| | | | | | | | | leakage |
| Comparative | P22 | F4 | Comparative | 29 | 99.96% | >80° | >80° | Some |
| | | | Example 1 | | | | | light |
| | | | | | | | | leakage |
| Comparative | P23 | F5 | Comparative | 29 | 99.96% | >80° | >80° | Some |
| | | | Example 1 | | | | | light |
| | | | | | | | | leakage |
| Comparative | P24 | F6 | Comparative | 29 | 99.96% | >80° | >80° | Some |
| | | | Example 1 | | | | | light |
| | | | | | | | | leakage |
| Comparative | P25 | F7 | Comparative | 29 | 99.96% | >80° | >80° | Some |
| | | | Example 1 | | | | | light |
| | | | | | | | | leakage |
| Comparative | P26 | F1 | Comparative | 29 | 99.85% | 78° | 75° | Much |
| | | | Example 2 | | | | | light |
| | | | | | | | | leakage |
| Comparative | P27 | F2 | Comparative | 29 | 99.85% | 78° | 75° | Much |
| | | | Example 2 | | | | | light |
| | | | | | | | | leakage |
| Comparative | P28 | F3 | Comparative | 29 | 99.85% | 78° | 75° | Much |
| | | | Example 2 | | | | | light |
| | | | | | | | | leakage |
| Comparative | P29 | F4 | Comparative | 29 | 99.85% | 78° | 75° | Much |
| | | | Example 2 | | | | | light |
| | | | | | | | | leakage |
| Comparative | P30 | F5 | Comparative | 29 | 99.85% | 78° | 75° | Much |
| | | | Example 2 | | | | | light |
| | | | | | | | | leakage |
| Comparative | P31 | F6 | Comparative | 29 | 99.85% | 78° | 75° | Much |
| | | | Example 2 | | | | | light |
| | | | | | | | | leakage |
| Comparative | P32 | F7 | Comparative | 29 | 99.85% | 78° | 75° | Much |
| | | | Example 2 | | | | | light |
| | | | | | | | | leakage |
| Comparative | P33 | F10 | Example 1 | 29 | 99.97% | 75° | 70° | Not |
| | | | | | | | | observed |
| Comparative | P34 | F10 | Example 2 | 19 | 99.96% | 75° | 70° | Not |
| | | | | | | | | observed |
| Comparative | P35 | F10 | Comparative | 29 | 99.9% | 75° | 70° | Some |
| | | | Example 1 | | | | | light |
| | | | | | | | | leakage |
| Comparative | P36 | F10 | Comparative | 29 | 99.85% | 70° | 65° | Much |
| | | | Example 2 | | | | | light |
| | | | | | | | | leakage |
| Comparative | P37 | F11 | Example 1 | 19 | 99.97% | 75° | 70° | Not |
| | | | | | | | | observed |
| Comparative | P38 | F11 | Example 2 | 21 | 99.96% | 75° | 70° | Not |
| | | | | | | | | observed |
| Comparative | P39 | F11 | Comparative | 29 | 99.96% | 75° | 70° | Some |
| | | | Example 1 | | | | | light |
| | | | | | | | | leakage |
| Comparative | P40 | F11 | Comparative | 29 | 99.85% | 70° | 65° | Much |
| | | | Example 2 | | | | | light |
| | | | | | | | | leakage |
| Comparative | P41 | F12 | Example 1 | 19 | 99.97% | 75° | 70° | Not |
| | | | | | | | | observed |
| Comparative | P42 | F12 | Example 2 | 21 | 99.96% | 75° | 70° | Not |
| | | | | | | | | observed |
| Comparative | P43 | F12 | Comparative | 29 | 99.96% | 75° | 70° | Some |
| | | | Example 1 | | | | | light |
| | | | | | | | | leakage |
| Comparative | P44 | F12 | Comparative | 29 | 99.96% | 70° | 65° | Much |
| | | | Example 2 | | | | | light |
| | | | | | | | | leakage |

The polarizing plate of the invention exhibits excellent optical compensation properties. It is also made obvious that the polarizing plate of the invention can provide a VA mode liquid crystal display device having a wide viewing angle and little light leakage with time.

### Example 2

### 1. Preparation of Polarizing Plate 02 with Anti-Reflection Layer

(Preparation of Coating Solution for Light-Scattering Layer)

50 g of a mixture of pentaerythritol triacrylate and pentaerythritol tetraacrylate (“PETA”, 10 produced by NIPPON KAYAKU CO., LTD.) was diluted with 38.5 g of toluene. To the solution was then added 2 g of a polymerization initiator (“Irgacure 184”, produced by Ciba Specialty Chemicals Co., Ltd.). The mixture was then stirred. The solution thus prepared was spread, and then irradiated with ultraviolet rays to undergo curing. The coat layer thus obtained had a refractive index of 1.51.

To this solution were then added 1.7 g of a 30 wt-% toluene dispersion of a particulate crosslinked polystyrene having an average particle diameter of 3.5 μm (refractive index: 1.60; “SX-350”, produced by Soken Chemical & Engineering Co., Ltd.) and 13.3 g of a 305 toluene dispersion of a particulate crosslinked acryl-styrene having an average particle diameter of 3.5 μm (refractive index: 1.55, produced by Soken Chemical & Engineering Co., Ltd.) which had both been dispersed at 10,000 rpm by a polytron dispersing machine for 20 minutes. Finally, to the solution were added 0.75 g of a fluorine-based surface modifier (FP-1) and 10 g of a silane coupling agent (KBM-5103, produced by Shin-Etsu Chemical Co., Ltd.) to obtain a completed solution.

The aforementioned mixture was then filtered through a polypropylene filter having a pore diameter of 30 μm to prepare a light-scattering layer coating solution. 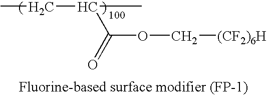
(Preparation of Coating Solution for Lower Refractive Layer)

13 g of a thermally-crosslinkable fluorine-containing polymer (JN-7228; solid concentration: 6%; produced by JSR Co., Ltd.), 1.3 g of silica sol (silica having a particle size different from that MEK-ST; average particle size: 45 nm; solid concentration: 30%; produced by NISSAN CHEMICAL INDUSTRIES, LTD.), 0.6 g of the sol a thus prepared, 5 g of methyl ethyl ketone and 0.6 g of cyclohexanone were mixed with stirring. The solution was then filtered through a polypropylene filter having a pore diameter of 1 μm to prepare a lower refractive layer coating solution.

(Preparation of Transparent Protective Film 01 with Anti-Reflection Layer)

The aforementioned coating solution for functional layer (light-scattering layer) was spread over a triacetyl cellulose film having a thickness of 80 μm (Fujitac TD80U, produced by Fuji Photo Film Co., Ltd.) which was being unwound from a roll at a gravure rotary speed of 30 rpm and a conveying speed of 30 m/min using a mircogravure roll with a diameter of 50 mm having 180 lines/inch and a depth of 40 μm and a doctor blade. The coated film was dried at 60° C. for 150 seconds, irradiated with ultraviolet rays at an illuminance of 400 mW/cm² and a dose of 250 mJ/cm² from an air-cooled metal halide lamp having an output of 160 W/cm (produced by EYE GRAPHICS CO., LTD.) in an atmosphere in which the air within had been purged with nitrogen so that the coat layer was cured to form a functional layer to a thickness of 6 μm. The film was then wound.

The coating solution for lower refractive layer thus prepared was spread over the triacetyl cellulose film having a functional layer (light-scattering layer) provided thereon was being unwound at a gravure rotary speed of 30 rpm and a conveying speed of 15 m/min using a mircogravure roll with a diameter of 50 mm having 180 lines/inch and a depth of 40 μm and a doctor blade. The coated film was dried at 120° C. for 150 seconds and then at 140° C. for 8 minutes. The film was irradiated with ultraviolet rays at an illuminance of 400 mW/cm² and a dose of 900 mJ/cm² from an air-cooled metal halide lamp having an output of 240 W/cm (produced by EYE GRAPHICS CO., LTD.) in an atmosphere in which the air within had been purged with nitrogen to form a lower refractive layer to a thickness of 100 μm. The film was then wound.

(Preparation of Polarizing Plate 02)

A polarizing film was prepared in the same manner as in Example 1.

The transparent protective film 01 with anti-reflection layer thus prepared was subjected to saponification in the same manner as in Example 1, and then stuck to one side of a polarizing film with a polyvinyl alcohol-based adhesive. The cellulose acylate film F1 prepared in Example 1 was subjected to saponification in the same manner as in Example 1, and then stuck to the other side of the polarizing film with a polyvinyl alcohol-based adhesive.

The laminate was arranged such that the transmission axis of the polarizing film and the slow axis of the cellulose acylate film F1 are aligned parallel to each other. The laminate was also arranged such that the transmission axis of the polarizing film and the slow axis of the commercially available cellulose triacetate film are aligned perpendicular to each other. Thus, a polarizing plate 02 was prepared.

Integrating sphere average reflectance was used in place of specular reflectance. Using a spectrophotometer produced by JASCO CO., LTD., the polarizing plate was measured for spectral reflectance at an incidence angle of 5° at a wavelength of from 380 nm to 780 nm to determine the integrating sphere average reflectance at a wavelength of from 450 nm to 650 nm. The result was 2.3%.

### 2. Preparation of Polarizing Plate 03 with Anti-Reflection Layer

(Preparation of Coating Solution for Hard Coat Layer)

To 750.0 parts by weight of a trimethylolpropane triacrylate (TMPTA, produced by NIPPON KAYAKU CO., LTD.) were added 270.0 parts by weight of a poly(glycidyl methacrylate) having a weight-average molecular weight of 3,000, 730.0 g of methyl ethyl ketone, 500.0 g of cyclohexanone and 50.0 g of a photopolymerization initiator (Irgacure 184, produced by Ciba Geigy Japan Inc.). The mixture was then stirred. The mixture was then filtered through a polypropylene filter having a pore diameter of 0.4 μm to prepare a hard coat layer coating solution.

(Preparation of Fine Dispersion of Titanium Dioxide)

As the particulate titanium dioxide there was used a particulate titanium dioxide containing cobalt surface-treated with aluminum hydroxide and zirconium hydroxide (MPT-129, produced by ISHIHARA SANGYO KAISHA, LTD.). To 257.1 g of the particulate titanium dioxide were then added 38.6 g of the following dispersant and 704.3 g of cyclohexanone. The mixture was then dispersed using a dinomill to prepare a dispersion of titanium dioxide particles having a weight-average particle diameter of 70 nm.

(Preparation of Middle Layer Coating Solution)

To 88.9 g of the aforementioned dispersion of titanium dioxide particles were added 58.4 g of a mixture of dipentaerytritol petaacrylate and dipentaerythritol hexaacrylate (DPHA), 3.1 g of a photopolymerization initiator (Irgacure 907), 1.1 g of a photosensitizer (Kayacure DETX, produced by NIPPON KAYAKU CO., LTD.), 482.4 g of methyl ethyl ketone and 1,869.8 g of cyclohexanone. The mixture was then stirred. The mixture was thoroughly stirred, and then filtered through a polypropylene filter having a pore diameter of 0.4 μm to prepare a middle refractive layer coating solution.

(Preparation of Higher Refractive Layer Coating Solution)

To 586.8 g of the aforementioned dispersion of titanium dioxide particles were added 47.9 g of a mixture of dipentaerytritol petaacrylate and dipentaerythritol hexaacrylate (DPHA), 4.0 g of a photopolymerization initiator (Irgacure 907), 1.3 g of a photosensitizer (Kayacure DETX, produced by NIPPON KAYAKU CO., LTD.), 455.8 g of methyl ethyl ketone and 1,427.8 g of cyclohexanone. The mixture was then stirred. The mixture was stirred, and then filtered through a polypropylene filter having a pore diameter of 0.4 μm to prepare a higher refractive layer coating solution.

(Preparation of Lower Refractive Layer Coating Solution)

The following perfluoroolefin copolymer (1) was dissolved in methyl ethyl ketone in such an amount that the concentration reached 7% by weight. To the solution were then added a methacrylate group-terminated silicone resin X-22-164C (produced by Shin-Etsu Chemical Co., Ltd.) and a photoradical generator Irgacure 907 (trade name) in an amount of 3% and 5% by weight, respectively, to prepare a lower refractive layer coating solution. 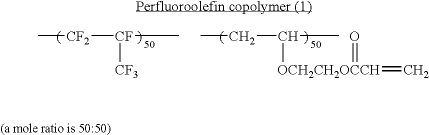
(Preparation of Transparent Protective Film 02 with Anti-Reflection Layer)

A hard coat layer coating solution was spread over a triacetyl cellulose film having a thickness of 80 μm (Fujitack TD80U, produced by Fuji Photo Film Co., Ltd.) using a gravure coater. The coated film was dried at 100° C., and then irradiated with ultraviolet rays at an illuminance of 400 mW/cm² and a dose of 300 mJ/cm² from an air-cooled metal halide lamp having an output of 160 W/cm (produced by EYE GRAPHICS CO., LTD.) in an atmosphere in which the air within had been purged with nitrogen to reach an oxygen concentration of 1.0 vol-% or less so that the coat layer was cured to form a hard coat layer to a thickness of 8 μm. The middle refractive layer coating solution, the higher refractive layer coating solution and the lower refractive layer coating solution were continuously spread over the hard coat layer using a gravure coater having three coating stations.

The drying conditions of the middle refractive layer were 100° C. and 2 minutes. Referring to the ultraviolet curing conditions, the air in the atmosphere was purged with nitrogen so that the oxygen concentration reached 1.0 vol-% or less. In this atmosphere, ultraviolet rays were emitted at an illuminance of 400 mW/cm² and a dose of 400 mJ/cm² by an air-cooled metal halide lamp having an output of 180 W/cm (produced by EYE GRAPHICS CO., LTD.). The middle refractive layer thus cured had a refractive index of 1.630 and a thickness of 67 nm.

The drying conditions of the higher refractive layer and the lower refractive layer were 90° C. and 1 minute followed by 100° C. and 1 minute. Referring to the ultraviolet curing conditions, the air in the atmosphere was purged with nitrogen so that the oxygen concentration reached 1.0 vol-% or less. In this atmosphere, ultraviolet rays were emitted at an illuminance of 600 mW/cm² and a dose of 600 mJ/cm² by an air-cooled metal halide lamp having an output of 240 W/cm (produced by EYE GRAPHICS CO., LTD.). The higher refractive layer thus cured had a refractive index of 1.905 and a thickness of 107 nm and the lower refractive layer thus cured had a refractive index of 1.440 and a thickness of 85 nm. Thus, a transparent protective film 02 with anti-reflection layer was prepared.

(Preparation of Polarizing Plate 03)

A polarizing plate 03 was prepared in the same manner as in the polarizing plate 02 except that the transparent protective film with anti-reflection layer was used instead of the transparent protective film 01 with anti-reflection layer.

Integrating sphere average reflectance was used in place of specular reflectance. Using a spectrophotometer produced by JASCO CO., LTD., the polarizing plate was measured for spectral reflectance at an incidence angle of 5° at a wavelength of from 380 nm to 780 nm to determine the integrating sphere average reflectance at a wavelength of from 450 nm to 650 nm. The result was 0.4%.

### 3. Mounting on VA Panel

A pair of polarizing plates and a pair of optical compensation sheets were peeled off a liquid crystal display device comprising a vertically aligned liquid crystal cell to obtain the liquid crystal cell in the same manner as in Example 1.

The polarizing plate 02 thus prepared was then stuck to the liquid crystal cell on the viewer's side thereof with an adhesive with the transparent protective film 1 with anti-reflection layer prepared facing the liquid crystal cell. The polarizing plate P1 was stuck to the liquid crystal cell on the backlight side thereof with an adhesive with the cellulose acylate film F1 prepared facing the liquid crystal cell. The laminate was arranged in crossed nicols such that the transmission axis of the viewer's side polarizing plate is aligned vertically and the transmission axis of the backlight side polarizing plate is aligned horizontally.

The polarizing plate 03 was stuck to the liquid crystal cell in the same manner as mentioned above to prepare a liquid crystal display device. The liquid crystal display device thus prepared was then observed. As a result, it was found that neutral black display had been realized in the forward direction as well as in the viewing direction. The liquid crystal display device also exhibited a good front contrast.

The liquid crystal display device was also evaluated for light leakage. As a result, no light leakage was observed to advantage.

It is thus made obvious that the polarizing plate of the invention exhibits excellent optical compensation properties and thus can provide a VA mode liquid crystal display device having a wide viewing angle and little light leakage with time.

### INDUSTRIAL APPLICABILITY

An polarizing plate according to the invention can be used to a liquid crystal display device having a wide viewing angle and little light leakage with time.

It will be apparent to those skilled in the art that various modifications and variations can be made to the described preferred embodiments of the invention without departing from the spirit or scope of the invention. Thus, it is intended that the present invention cover all modifications and variations of this invention consistent with the scope of the appended claims and their equivalents.

This application is based on Japanese Patent Application No. JP2004-183811 filed on Jun. 22 of 2004, the contents of which is incorporated herein by reference.

1. A polarizing plate comprising:
a polarizing film; and
two transparent protective films, wherein the polarizing film is between the two transparent protective films, and at least one of the two transparent protective films is an optical compensatory sheet comprising a cellulose acylate film, the cellulose acylate film having a thickness of from 40 to 180 μm,
wherein
the polarizing plate has a thickness of 22 μm or less, and
the polarizing plate has a polarization degree P calculated by formula (1) of 99.99% or more:
Polarization degree P=((H0−H1)/(H0+H1))^{1/2}×100 (1)
wherein H0 represents a transmittance of two polarizing plates at the time the two polarizing plates are stacked on each other such that absorption axes of the two polarizing plates correspond with each other; and H1 represents a transmittance of two polarizing plate at the time the two polarizing plates are stacked on each other such that the absorption axes of the two polarizing plates are perpendicular to each other.

2. The polarizing plate as defined in claim 1, wherein the polarizing plate has a thickness of 20 μm or less.

3. The polarizing plate as defined in claim 1, wherein the optical compensation sheet has: Re retardation value of from 20 to 80 nm; Rth retardation of from 70 to 400 nm; and a ratio of the Re retardation value to the Rth retardation value of from 0.1 to 0.5.

4. The polarizing plate as defined in claim 3, wherein the cellulose acylate film comprises a mixed aliphatic acid ester of cellulose, wherein a hydroxyl group of the cellulose is substituted by an acetyl group, and another hydroxyl group of the cellulose is substituted by an acyl group having 3 or more carbon atoms; and the cellulose acylate film satisfies formulae (4) and (5):
2.0≦A+B≦3.0 (4)
0≦B (5)
wherein A is a degree of substitution by the acetyl group; and B is a degree of substitution by the acyl group having 3 or more carbon atoms.

5. The polarizing plate as defined in claim 4, wherein the acyl group is a butyryl group.

6. The polarizing plate as defined in claim 4, wherein the acyl group is a propionyl group, and the degree B is 1.3 or more.

7. The polarizing plate as defined in claim 4, wherein a sum of the degree of substitution of hydroxyl group in a 6 position of cellulose is 0.75 or more.

8. The polarizing plate as defined in claim 4, wherein DS2, DS3 and DS5 respectively representing degrees of substitution of hydroxyl groups in 2, 3 and 6 positions of a glucose unit of the cellulose by an acyl group having 2 or more carbon atoms satisfy:
2.0≦DS2+DS3+DS6≦3.0 (I)
DS6/(DS2+DS3+DS6)≧0.315 (II)

9. The polarizing plate as defined in claim 1, wherein the cellulose acylate film comprises a compound containing at least two aromatic rings in an amount of from 0.01 to 20 parts by weight based on parts by weight of cellulose acylate.

10. The polarizing plate as defined in claim 9, wherein the compound containing at least two aromatic rings is a rod-shaped compound having a linear molecular structure.

11. The polarizing plate as defined in claim 1, wherein the cellulose acylate film is a film stretched at a draw ratio of from 3 to 100%.

12. The polarizing plate as defined in claim 11, wherein the cellulose acylate film comprises a cellulose acylate having an acetylation degree of from 59.0 to 61.5%; and an amount of Re/Rth change of from 0.01 to 0.1 per 1% of draw ratio.

13. The polarizing plate as defined in claim 1, wherein the cellulose acylate film is a film stretched in a direction perpendicular to a longitudinal direction with a content of residual solvent in the cellulose acylate film, the content being kept to a range of from 2 to 30% by weight while the film being conveyed in the longitudinal direction; and the optical compensation sheet has a low axis aligned in the direction perpendicular to the longitudinal direction thereof.

14. The polarizing plate as defined in claim 1, wherein one of the two transparent protective films is the optical compensation sheet comprising the cellulose acylate film; the other of the two transparent protective film has an anti-reflection layer having a specular reflectance of 2.5% or less; and the anti-reflection layer comprises a light scattering layer and a lower refractive index layer.

15. The polarizing plate as defined in claim 1, wherein one of the two transparent protective films is the optical compensation sheet comprising the cellulose acylate film; the other of the two transparent protective film has an anti-reflection layer having a specular reflectance of 2.5% or less; and the anti-reflection layer comprises a middle refractive layer, a higher refractive layer, and a lower refractive layer in this order.

16. A liquid crystal display device comprising:
a liquid crystal cell of VA mode; and
two polarizing plates, wherein the liquid crystal cell is between the two polarizing plate, and at least one of the two polarizing plates is a polarizing plate as defined in claim 1,
wherein
the optical compensation sheet of the polarizing plate is disposed on a liquid crystal cell side of the polarizing film,
and a slow axis of the optical compensation sheet and a transmission axis of the polarizing film adjacent of the optical compensation sheet are aligned substantially parallel to each other.

17. A liquid crystal display device comprising:
a liquid crystal cell of VA mode; and
two polarizing plates, wherein the liquid crystal cell is between the two polarizing plate, and at least one of the two polarizing plates is a polarizing plate as defined in claim 14,
wherein
the anti-reflection layer is disposed on a viewing side of the polarizing film, and
a slow axis of the optical compensation sheet and a transmission axis of the polarizing film adjacent of the optical compensation sheet are aligned substantially parallel to each other.
